(19) United States
(12) Patent Application Publication
(10) Pub. No.: US 2024/0209916 A1
(43) Pub. Date: Jun. 27, 2024

(54) ACTIVE VIBRATION CONTROL DEVICE AND METHOD OF MANUFACTURING THE SAME

(71) Applicant: HONDA MOTOR CO., LTD., Tokyo (JP)

(72) Inventors: Yuho ITO, Wako-shi (JP); Toshio INOUE, Wako-shi (JP)

(21) Appl. No.: 18/494,000

(22) Filed: Oct. 25, 2023

(30) Foreign Application Priority Data
Dec. 23, 2022 (JP) 2022-206591
Aug. 1, 2023 (JP) 2023-125234

(51) Int. Cl. F16F 15/03

(52) U.S. Cl. CPC F16F 15/03

(57) ABSTRACT

An active vibration control device includes: an outer hollow cylinder; an inner hollow cylinder arranged radially inside the outer hollow cylinder; a magnet coil (magnetic field generator) to generate a magnetic field; a magnetic material to provide a magnetic circuit by the magnetic field; a first liquid chamber filled with magneto-viscoelastic fluid; and a second liquid chamber adjacent to the first liquid chamber and filled with liquid, wherein the magnet coil, the magnetic material, the first liquid chamber, and the second liquid chamber are provided radially between the inner hollow cylinder and the outer hollow cylinder, the first liquid chamber is separated from the second liquid chamber by a flexible member, and the first liquid chamber has an orifice, through which the magnetic circuit is provided.

### CROSS-REFERENCE TO RELATED APPLICATION

This application claims the benefit of priority under 35 U.S.C. § 119 to Japanese Patent Application No. 2022-206591 filed on Dec. 23, 2022 and Japanese Patent Application No. 2023-125234 filed on Aug. 1, 2023, the entire contents of which are incorporated herein by reference.

### TECHNICAL FIELD

The present invention relates to an active vibration control device and a method of manufacturing the same.

### BACKGROUND OF THE INVENTION

Efforts have been actively made in recent years to provide access to sustainable transportation systems friendly to vulnerable transportation participants, such as the elderly, disabled people, and children. To this end, efforts in research and development have been focused on further improving safety and convenience in transportation through developments on occupant comfort in a vehicle. For the purpose of improving occupant comfort in a vehicle through reduction in noise and vibration within a compartment, active vibration control devices have been offered that are each used such as for a subframe mount and a suspension bush (see Japanese Patent Application Publication No. 2021-71117, referred to as Patent Document 1 hereinbelow, for example). In particular, the active vibration control device in Patent Document 1 has two liquid chambers filled with magneto-viscoelastic fluid communicated with each other via a flow path and includes an exciting coil to provide a magnetic circuit in a direction intersecting the flow path. The active vibration control device varies density of magnetic flux by the exciting coil, when the magneto-viscoelastic fluid flows from one of the two liquid chambers toward the other in response to the magnitude of amplitude by inputted vibration, to control flow of the magneto-viscoelastic fluid. In this manner, the active vibration control device accomplishes flexible damping property in response to the magnitude of amplitude by inputted vibration.

### SUMMARY

### Problems to be Solved

A conventional active vibration control device (see Patent Document 1, for example) may have volume of the liquid chambers increased to improve performance of response to amplitude by inputted vibration, eventually causing an amount of the magneto-viscoelastic fluid filled in the liquid chambers to be increased, which includes magnetic powder and is therefore comparatively heavy and expensive. This brings additional problems for the active vibration control device that manufacturing costs increase and a vehicle mounted with the device increases in weight. Additionally, the active vibration control device has more absolute amount of deposition of magnetic powder contained in the magneto-viscoelastic fluid, in proportion to increasing usage of the magneto-viscoelastic fluid, to have a risk of performance of the active vibration control device degraded.

The present invention is intended to provide an active vibration control device to improve performance of response to an external force, such as inputted vibration and a load, without increasing volume of the liquid chambers to be filled with magneto-viscoelastic fluid, and to prevent performance of the device from being degraded due to magnetic powder in the magneto-viscoelastic fluid being deposited in the liquid chambers, as well as a method of manufacturing the same. The present invention then contributes to fostering sustainable transportation systems.

### Solution to Problems

An active vibration control device according to the present invention, to solve the above-identified problems, includes: an outer hollow cylinder; an inner hollow cylinder arranged radially inside the outer hollow cylinder; a magnetic field generator to generate a magnetic field; a magnetic material to provide a magnetic circuit by the magnetic field; a first liquid chamber filled with magneto-viscoelastic fluid; and a second liquid chamber adjacent to the first liquid chamber and filled with liquid, wherein the magnetic field generator, the magnetic material, the first liquid chamber, and the second liquid chamber are provided radially between the inner hollow cylinder and the outer hollow cylinder, the first liquid chamber is separated from the second liquid chamber by a flexible member, and a portion of the first liquid chamber works as a flow path of the magneto-viscoelastic fluid, through which the magnetic circuit is provided.

The present invention to solve the above-identified problems further provides a method of manufacturing the active vibration control device, the method including: a sealing step of sealing the magneto-viscoelastic fluid in the first liquid chamber, wherein the sealing step is implemented by putting together the magnetic field generator, the magnetic material, and the flexible member, with all of these submerged in liquid of the magneto-viscoelastic fluid.

### Advantageous Effects of the Invention

The active vibration control device and the method of manufacturing the same according to the present invention improve performance of response to an external force, such as inputted vibration and a load, without increasing volume of the liquid chambers to be filled with magneto-viscoelastic fluid, and prevent performance of the device from being degraded due to magnetic powder in the magneto-viscoelastic fluid being deposited in the liquid chambers.

### BRIEF DESCRIPTION OF DRAWINGS

FIG. 1A is a side view of an active vibration control device according to a first embodiment of the present invention;

FIG. 1B is a top view of the active vibration control device in FIG. 1A, as viewed from a direction indicated by an arrow IB;

FIG. 2 is a perspective view of the active vibration control device, partially sectioned along a line II-II in FIG. 1B;

FIG. 3 is a perspective view of the disassembled active vibration control device in FIG. 1A;

FIG. 4 is a cross-sectional view of the active vibration control device, taken along a line IV-IV in FIG. 1B;

FIG. 5 is a perspective view of a partially-sectioned assembly of a first-liquid-chamber definer and a magnetic field provider in the active vibration control device;

FIG. 6A is a diagram to show action of liquid in a second liquid chamber when a load has been inputted to, in a direction orthogonal to an axis of, an inner hollow cylinder;

FIG. 6B is a diagram to show movement of magneto-viscoelastic fluid, when a bottom wall of a flexible member has bent;

FIG. 6C is a schematic diagram to show behavior of magnetic powder, when a magnetic field has been applied through an orifice of a first liquid chamber;

FIG. 7A is a cross-sectional view of an active vibration control device according to a second embodiment of the present invention;

FIG. 7B is a cross-sectional view of an active vibration control device according to a third embodiment of the present invention;

FIG. 7C is a cross-sectional view of an active vibration control device according to a fourth embodiment of the present invention;

FIG. 8A is a perspective view of a disassembled active vibration control device according to a fifth embodiment of the present invention;

FIG. 8B is a perspective view of a second magnetic circuit provider in FIG. 8A;

FIG. 9 is a perspective view of a partially-sectioned assembly of a first-liquid-chamber definer and a magnetic field provider in the active vibration control device according to the fifth embodiment of the present invention;

FIG. 10 is a perspective view of the partially-sectioned active vibration control device according to the fifth embodiment of the present invention, with a magnetic circuit through an orifice provided by a magnetic coil applied with a current;

FIG. 11 is a cross-sectional view of an active vibration control device according to a sixth embodiment of the present invention;

FIG. 12 is a partially-enlarged cross-sectional view of a portion XII in FIG. 11;

FIG. 13 is a partially-enlarged cross-section view of the active vibration control device according to the sixth embodiment of the present invention, with a magnetic circuit through an orifice provided by a magnetic coil applied with a current;

FIG. 14 is a cross-sectional view of an active vibration control device according to a seventh embodiment of the present invention;

FIG. 15 is a partially-enlarged cross-sectional view of a portion XV in FIG. 14;

FIG. 16 is a partially-enlarged cross-section view of the active vibration control device according to the seventh embodiment of the present invention, with a magnetic circuit through an orifice provided by a magnetic coil applied with a current;

FIG. 17 is a perspective view of the disassembled active vibration control device according to an eighth embodiment of the present invention;

FIG. 18 is a vertical cross-sectional view of an active vibration control device according to a ninth embodiment of the present invention;

FIG. 19 is an overall perspective view of an assembly of a first-liquid-chamber definer and a magnetic field provider in the active vibration control device according to the ninth embodiment;

FIG. 20 is a perspective view of the disassembled assembly of the first-liquid-chamber definer and the magnetic field provider in the active vibration control device according to the ninth embodiment;

FIG. 21A is an overall perspective view of a flexible member in FIG. 20, as viewed from the bottom;

FIG. 21B is a cross-sectional view of the flexible member, taken along a line XXIb-XXIb in FIG. 21A;

FIG. 22 is an overall perspective view of a first magnetic circuit provider in FIG. 20, as viewed from the top;

FIG. 23 is an overall perspective view of a second magnetic circuit provider in FIG. 20, as viewed from the bottom;

FIG. 24 illustrates behavior of a first-liquid-chamber definer in FIG. 20; and FIG. 25 is a partially enlarged cross-sectional view of a section XXV in FIG. 18.

### DETAILED DESCRIPTION

### First Embodiment

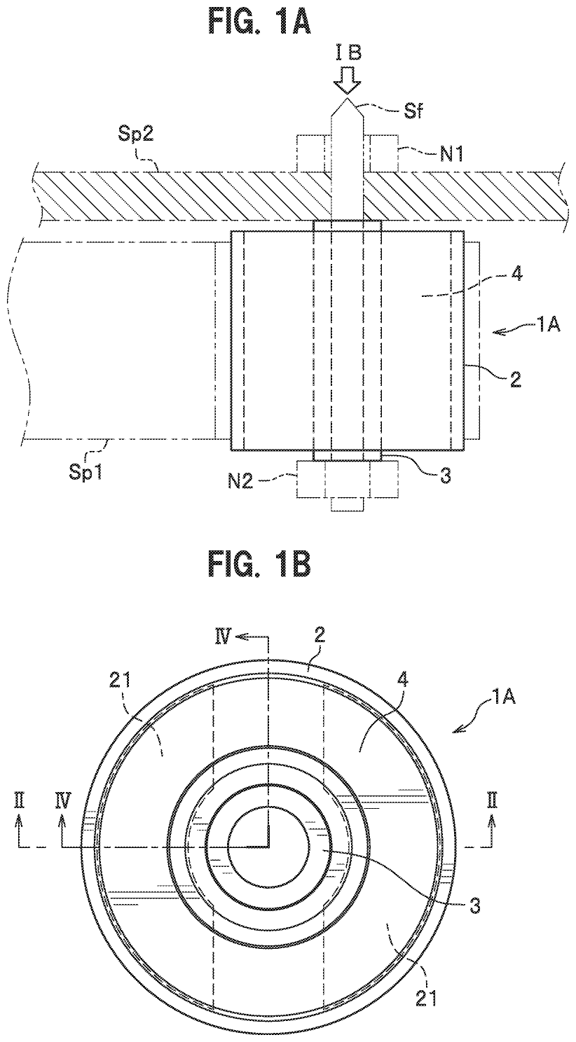

Next, a description is given in detail of embodiments (first to ninth embodiments) of the present invention, with reference to the drawings as required. FIG. 1A is a side view of an active vibration control device 1A according to a first embodiment of the present invention. FIG. 1B is a top view of the active vibration control device 1A in FIG. 1A, as viewed from a direction indicated by an arrow IB.

### Outer Hollow Cylinder

As shown in FIGS. 1A and 1B, the active vibration control device 1A of the present embodiment includes an outer hollow cylinder 2; an inner hollow cylinder 3 arranged radially inside, and substantially coaxially with, the outer hollow cylinder 2; and a damper body 4 arranged between the outer hollow cylinder 2 and the inner hollow cylinder 3. Note that a reference sign Sp1 in FIG. 1A indicates a first support member supporting the active vibration control device 1A, and a reference sign Sp2 indicates a second support member supporting the active vibration control device 1A. The first support member Sp1 and the second support member Sp2 are shown with virtual lines (dash-dot-dot-dash lines). The outer hollow cylinder 2 is formed of a cylindrical body having a larger diameter than the inner hollow cylinder 3. The outer hollow cylinder 2 of the present embodiment is made of a non-magnetic material. The non-magnetic material includes an aluminum alloy, nonferritic SUS, copper, and an engineering plastic, but is not limited to one of these. The outer hollow cylinder 2 is supported, on an outer periphery thereof, by the first support member Sp1, as shown in FIG. 1A.

### Inner Hollow Cylinder

The inner hollow cylinder 3 is formed longer in an axis direction than the outer hollow cylinder 2, as shown in FIG. 1A. Ends in an axis direction of the inner hollow cylinder 3 slightly protrude outward in the axis direction than those of the outer hollow cylinder 2. Note that the inner hollow cylinder 3 of the present embodiment is assumed to be made of non-magnetic material.

As shown in FIG. 1A, the inner hollow cylinder 3 is inserted therein, radially inside thereof, with an axial member Sf having threaded portions at both ends. The axial member Sf is shown with a virtual line (dash-dot-dot-dash line) in FIG. 1A. The axial member Sf has a nut N1 fastened thereonto at one end thereof penetrating the second support member Sp2, and a nut N2 fastened thereonto at the other end thereof protruding from the inner hollow cylinder 3. The nuts N1, N2 are shown with virtual lines (dash-dot-dot-dash lines) in FIG. 1A. This causes the inner hollow cylinder 3 to be supported by the second support member Sp2. Alternatively, the inner hollow cylinder 3 may have both ends of the axial member Sf penetrating a pair of the second support members Sp2 and fastened by the nuts N1, N2, respectively, so as to be held between the pair of the second support members Sp2, even though not shown.

The active vibration control device 1A as described above has vibration from a designated vibration source and/or a load from outside (hereinbelow, sometimes simply referred to as “vibration and the like”) inputted to the outer hollow cylinder 2 via the first support member Sp1, inputted to the inner hollow cylinder 3 via the second support member Sp2, or inputted to the outer hollow cylinder 2 and the inner hollow cylinder 3 via the first support member Sp1 and the second support member Sp2.

### Damper Body

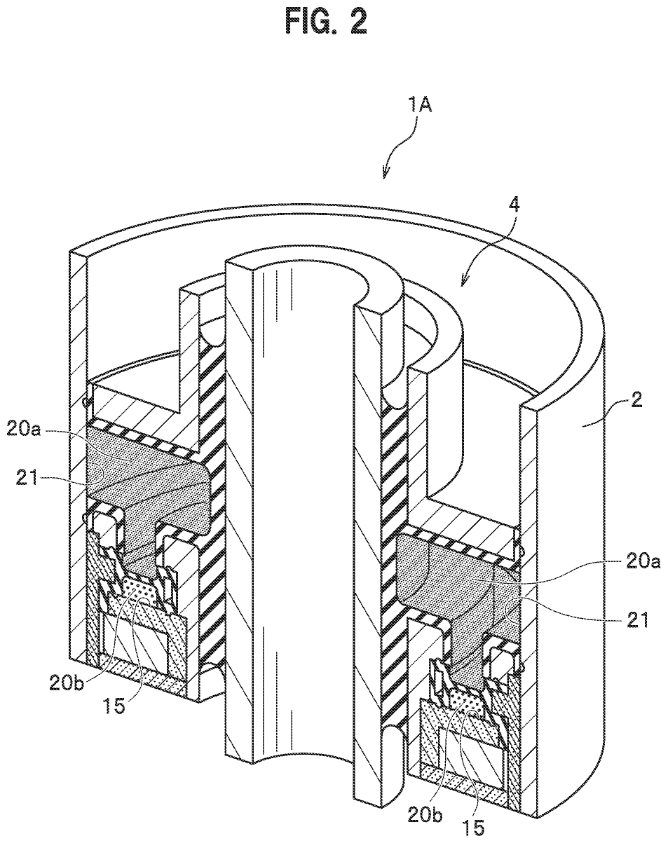

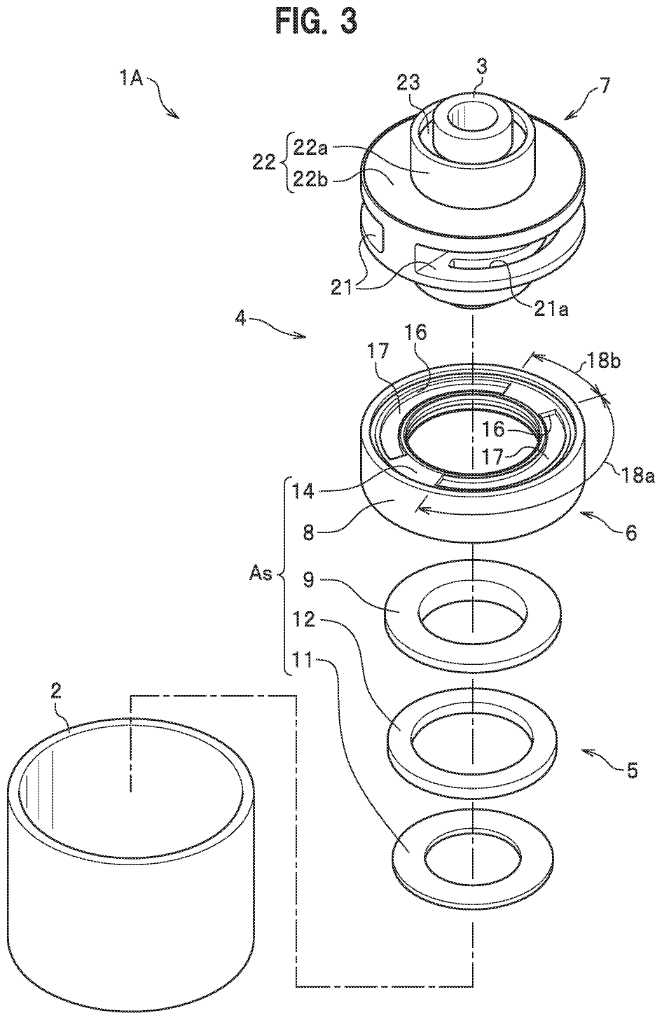

Next, a description is given of the damper body 4 (see FIG. 1B). The damper body 4 damps vibration and the like inputted from at least one of the outer hollow cylinder 2 (see FIG. 1B) and the inner hollow cylinder 3 (see FIG. 1B). FIG. 2 is a perspective view of the active vibration control device 1A, partially sectioned along a line II-II in FIG. 1B. FIG. 3 is a perspective view of the disassembled active vibration control device 1A. As shown in FIG. 2, the damper body 4 is arranged radially between the inner hollow cylinder 3 and the outer hollow cylinder 2. The damper body 4 has a first liquid chamber 15 filled with magneto-viscoelastic fluid 20b, and second liquid chambers 21 filled with liquid 20a as a medium of transmitting vibration and the like (to be described below).

In particular, the damper body 4 includes a first-liquid-chamber definer 6, a second-liquid-chamber definer 7, and a magnetic field provider 5, as shown in FIG. 3. Hereinbelow, a description is first given of the second-liquid-chamber definer 7 and then given of an assembly As having the first-liquid-chamber definer 6 integrated with the magnetic field provider 5.

### Second-Liquid-Chamber Definer

As shown in FIG. 3, the second-liquid-chamber definer 7 has a liquid chamber definer 22 to define the second liquid chambers 21, as partitions, on a radially outer side of the inner hollow cylinder 3, and an elastic support 23 to elastically support the liquid chamber definer 22 on an outer periphery of the inner hollow cylinder 3. The liquid chamber definer 22 has a substantially peg-top shape having an axis portion 22a in a cylindrical shape, with the inner hollow cylinder 3 arranged inside thereof, and a columnar portion 22b with a larger diameter than the axis portion 22a. The second liquid chambers 21 are defined by the columnar portion 22b of the liquid chamber definer 22 partly removed circumferentially.

The liquid chamber definer 22 as described above partly isolates, in the axis direction, a space between the inner hollow cylinder 3 and the outer hollow cylinder 2, when arranged radially inside the outer hollow cylinder 2, to define an inner space, and then partitions the inner space circumferentially to define a pair of the second liquid chambers 21 on the radially outer side of the inner hollow cylinder 3. The pair of the second liquid chambers 21 face each other across the inner hollow cylinder 3, out of phase with each other by 180 degrees, as indicated by phantom line (dotted line) in FIG. 1B. Note that inner walls on a radially outer side of the second liquid chambers 21 are defined by an inner wall of the outer hollow cylinder 2, as shown in FIG. 2.

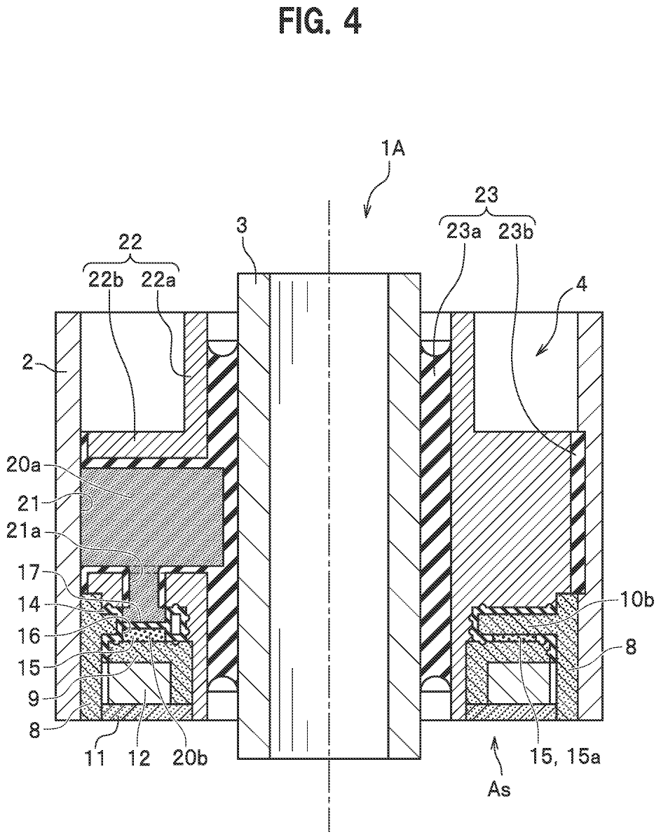

As shown in FIG. 3, the second liquid chamber 21 is provided therein with a communication groove 21a, in an arc-shaped slit, to face a groove concave 16 of a flexible member 14 (to be described below) of the first-liquid-chamber definer 6, when the second-liquid-chamber definer 7 is superimposed on the first-liquid-chamber definer 6. In particular, the communication groove 21a is formed to face the groove concave 16 of the flexible member 14 substantially in the center in a radial direction of the columnar portion 22b of the liquid chamber definer 22, as shown in FIG. 4 as a cross-sectional view taken along a line IV-IV in FIG. 1B. Note that a bottom wall 17 in the groove concave 16 of a flexible member 14 defines a part of the second liquid chamber 21 and also defines a part of the first liquid chamber 15, as will be described in detail below. The liquid chamber definer 22 of the present embodiment as described above is assumed to be made of a non-magnetic material. Known hydraulic oil such as silicon oil and ester oil may be suitably used as the liquid 20a filled in the second liquid chamber 21.

Next, a description is given of the elastic support 23 (see FIG. 3). As shown in FIG. 4, the elastic support 23 includes a cylindrical main body 23a arranged on an outer periphery of the inner hollow cylinder 3, and a covering 23b to axially cover a portion of the columnar portion 22b of the liquid chamber definer 22. Incidentally, the covering 23b also covers a circumferential surface of the columnar portion 22b and inner walls of the columnar portion 22b to define the second liquid chamber 21. The main body 23a of the elastic support 23 continues to the covering 23b on the circumferential surface of the columnar portion 22b via the covering 23b on the inner walls for the second liquid chamber 21.

The elastic support 23 of the present embodiment is assumed to be made of synthetic rubber such as silicon rubber, and is bonded by way of vulcanization to the inner hollow cylinder 3 and the columnar portion 22b. The main body 23a of the elastic support 23 as described above allows relative displacement between, in a direction orthogonal to the axes of, the inner hollow cylinder 3 and the outer hollow cylinder 2. Additionally, the covering 23b of the elastic support 23 secures sealing the liquid 20a filled in the second liquid chamber 21.

### Assembly

Next, a description is given of the assembly As (see FIG. 3), in a substantially cylindrical shape, integrally assembled from the first-liquid-chamber definer 6 (see FIG. 3) and the magnetic field provider 5 (see FIG. 3). As shown in FIG. 3, the first-liquid-chamber definer 6 includes the flexible member 14, a first magnetic circuit provider 8, and a second magnetic circuit provider 9. The first magnetic circuit provider 8 and the second magnetic circuit provider 9 double as the magnetic field provider 5.

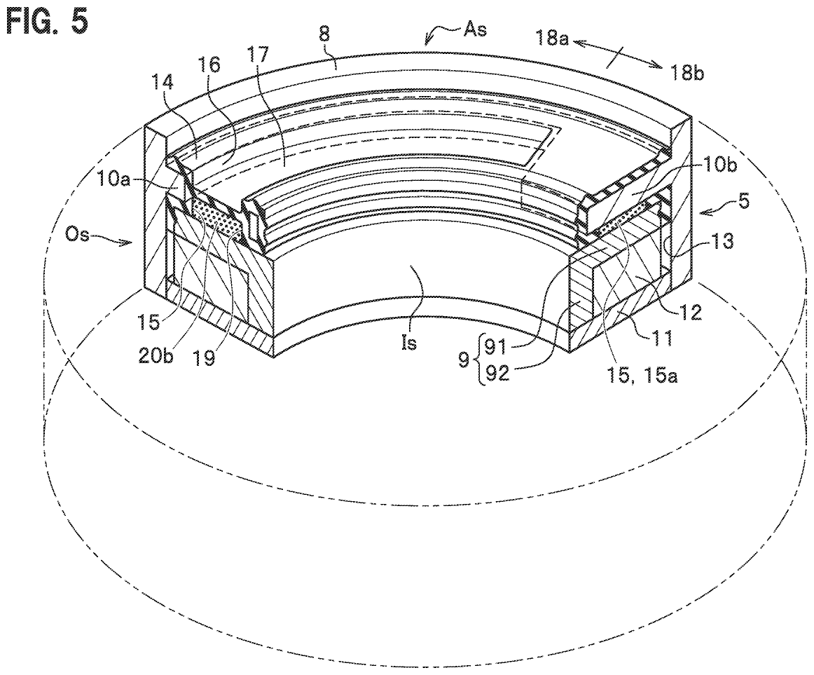

The flexible member 14 has a ring shape, as shown in FIG. 3, and is arranged inside the first magnetic circuit provider 8 in a cylindrical shape. The flexible member 14 has a pair of the groove concaves 16 in an arc shape, as described above. FIG. 5 is a perspective view of the partially-sectioned assembly As having cross-sections taken along a line IV-IV in FIG. 1B.

As shown in FIG. 5, a portion of the flexible member 14 formed with the groove concave 16 is provided, on an opposite side of the bottom wall 17 to the groove concave 16, with a liquid chamber concave 19 to define the first liquid chamber 15 in combination with the second magnetic circuit provider 9. The liquid chamber concave 19 of the flexible member 14 as described above is formed into an arc circumferentially so as to face the groove concave 16. That is, the second liquid chamber 21 is separated from the first liquid chamber 15 by the flexible bottom wall 17 of the flexible member 14, as shown in FIG. 4.

In addition, an outer periphery of the flexible member 14 is supported by the first magnetic circuit provider 8, as shown in FIG. 5. In particular, the outer periphery of the flexible member 14 having the liquid chamber concave 19 is fixed, with a flange 10a of the first magnetic circuit provider 8, extending radially inward at a height of the bottom wall 17 from an inner periphery of the first magnetic circuit provider 8, fitting into a wall in the outer periphery of the flexible member 14. A non-concaved portion 18b of the flexible member 14, where the bottom wall 17 is not formed, is fixed to a flange 10b of the first magnetic circuit provider 8, extending from the inner periphery of the first magnetic circuit provider 8 close to an inner periphery of the flexible member 14. Incidentally, a pair of concaved portions 18a of the flexible member 14, each formed with the bottom wall 17, is formed, as shown in FIG. 3, so as to correspond to the communication grooves 21a of the pair of the second liquid chambers 21.

As shown in FIG. 5, the first liquid chamber 15, extending in the circumferential direction so as to correspond to the bottom wall 17, still extends circumferentially in the non-concaved portion 18b, where the bottom wall 17 is not formed, between the flange 10b and the second magnetic circuit provider 9. As a result, a portion of the first liquid chamber 15 extending through the non-concaved portion 18b, where the bottom wall 17 is not formed, has a smaller cross-sectional area than a portion of the first liquid chamber 15 extending through the concaved portion 18a formed with the bottom wall 17. That is, a pair of large-cross-sectional-area portions of the first liquid chamber 15, each extending in an arc to correspond to the second liquid chamber 21, and a pair of small-cross-sectional-area portions of the first liquid chamber 15 form a liquid chamber in a ring shape, even though not shown.

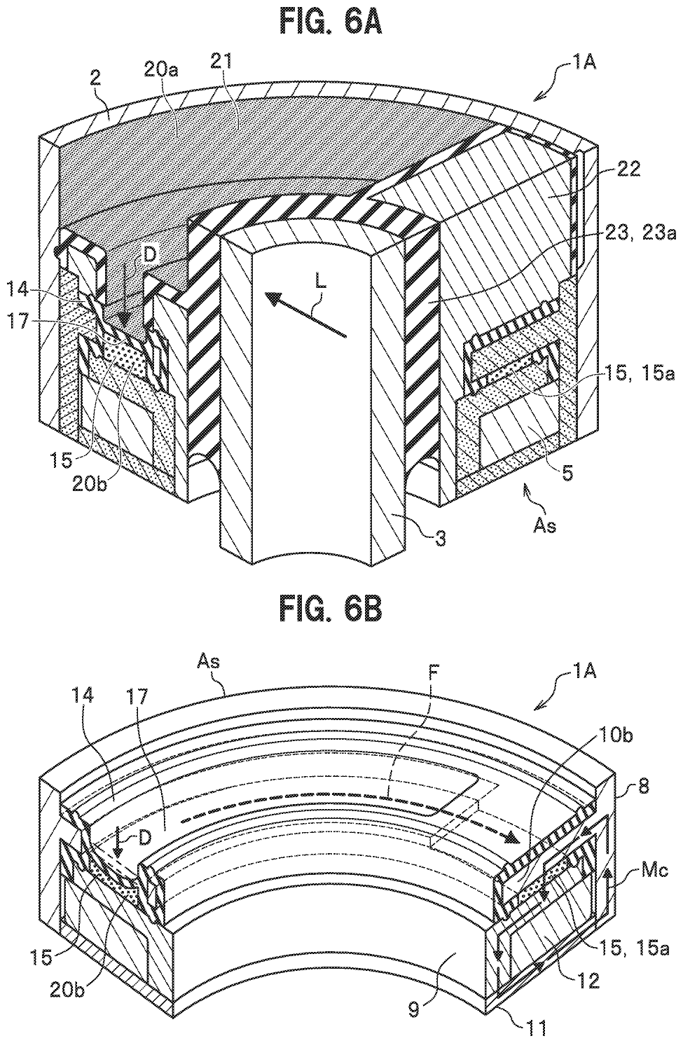

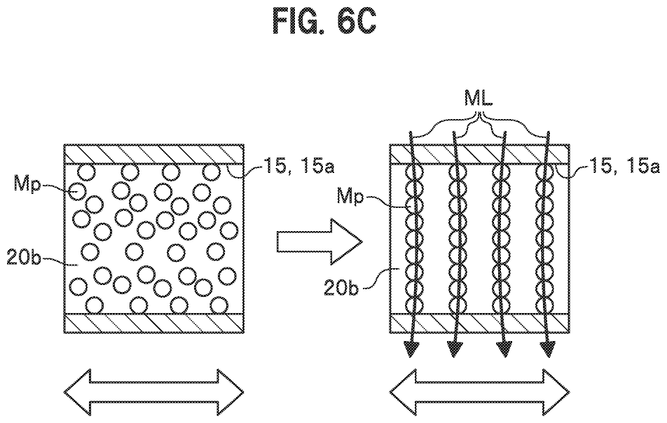

The first liquid chamber 15 formed into a ring shape is filled with magneto-viscoelastic fluid 20b, as described above. When the magneto-viscoelastic fluid moves between the pair of the large-cross-sectional-area portions of the first liquid chambers 15, the small-cross-sectional-area portion of the first liquid chamber 15 forms an orifice 15a, as will be described in detail below. That is, the orifice 15a as a portion of the first liquid chamber 15 works as a flow path of the magneto-viscoelastic fluid, through which the magnetic circuit Mc (see FIG. 6B) is provided. The magneto-viscoelastic fluid filled in the first liquid chambers 15 includes MRF (Magneto-Rheological Fluid) and MRC (Magneto-Rheological Compound), which are known to have magnetic powder dispersed such as into mineral oil or synthetic oil, to name a few.

Next, a description is given of the magnetic field provider 5 (see FIG. 5). The magnetic field provider 5 includes a magnet coil 12 and a third magnetic circuit provider 11, in addition to the first magnetic circuit provider 8 and the second magnetic circuit provider 9, as shown in FIG. 5. The magnet coil 12 corresponds to the “magnetic field generator” in one or more claims. As shown in FIG. 3, the second magnetic circuit provider 9, the magnet coil 12, and the third magnetic circuit provider 11 are each formed into a ring shape having a smaller diameter than the first magnetic circuit provider 8.

As shown in FIG. 5, the second magnetic circuit provider 9 includes a ring portion 91 in a flat plate shape and a cylindrical portion 92 formed on an inner periphery of the ring portion 91, to have an L-shape in cross section. The second magnetic circuit provider 9 having an L-shape in cross section, in combination with the third magnetic circuit provider 11 in a flat plate shape, presents a laterally-facing U-shape, opening outward in a radial direction. The second magnetic circuit provider 9 is arranged radially inside the first magnetic circuit provider 8 so as to define the orifice 15a between itself and the flange 10b of the first magnetic circuit provider 8, to define a room 13 for the magnet coil 12, radially inside the first magnetic circuit provider 8 and enclosed by the second magnetic circuit provider 9 and the third magnetic circuit provider 11. Here, the third magnetic circuit provider 11 is magnetically connected with the first magnetic circuit provider 8, and the second magnetic circuit provider 9 abuts on the first magnetic circuit provider 8 via the flexible member 14.

This causes the magnetic field provider 5 to provide a magnetic circuit Mc (see FIG. 6B) passing through the magneto-viscoelastic fluid 20b in the orifice 15a, by the magnet coil 12 applied with a current, as will be described below. Note that the first magnetic circuit provider 8, the second magnetic circuit provider 9, and the third magnetic circuit provider 11 are each assumed to be formed of a magnetic material such as iron, cobalt, nickel, and an alloy of one or more of these. The assembly As as described above is in a substantially cylindrical shape having an outer surface Os fitted into the outer hollow cylinder 2 (see FIG. 4), and an inner surface Is fitted onto the axis portion 22a (see FIG. 4) of the second-liquid-chamber definer 7, as shown in FIG. 5.

A method of manufacturing the active vibration control device 1A as described above includes, as shown in FIG. 3: a step of integrating the inner hollow cylinder 3 with the liquid chamber definer 22 via the elastic support 23; a step of assembling the assembly As to have the second magnetic circuit provider 9, the magnet coil 12, and the third magnetic circuit provider 11 fastened into the first magnetic circuit provider 8, which is integrally formed with the flexible member 14; and a step of fastening the integrated inner hollow cylinder 3 and liquid chamber definer 22 on the assembly As and then putting in the outer hollow cylinder 2.

In such a manufacturing method, a step (sealing step) of filling the magneto-viscoelastic fluid in the first liquid chamber 15 (see FIG. 5) of the assembly As is implemented by putting the second magnetic circuit provider 9 (magnetic material), the magnet coil 12, and the third magnetic circuit provider 11 (magnetic material) together with the first magnetic circuit provider 8 (magnetic material), with all of these submerged in liquid of the magneto-viscoelastic fluid.

### Advantageous Effects

Next, a description is given of advantageous effects of the active vibration control device 1A according to the present embodiment, with behavior of the active vibration control device 1A. FIG. 6A is a diagram to show action of the liquid 20a in the second liquid chamber 21 when an external force L has been inputted to, in a direction orthogonal to an axis of, the inner hollow cylinder 3. FIG. 6B is a schematic diagram to show movement of the magneto-viscoelastic fluid 20b, when the bottom wall 17 of the flexible member 14 has bent toward the first liquid chamber 15. FIG. 6C is a schematic diagram to show behavior of the magnetic powder Mp, when a magnetic field has been applied through the orifice 15a of the first liquid chamber 15.

As shown in FIG. 6A, relative positions of the inner hollow cylinder 3 and the outer hollow cylinder 2 are displaced in the active vibration control device 1A, when an external force L, such as a load and amplitude by vibration, has been inputted to, in a direction orthogonal to an axis of, the inner hollow cylinder 3. In a scene shown in FIG. 6A, the inner hollow cylinder 3 is displaced toward the outer hollow cylinder 2 to increase hydraulic pressure of the liquid 20a in the second liquid chamber 21. Additionally, the second liquid chamber 21 on an opposite side of the inner hollow cylinder 3 has hydraulic pressure of the liquid 20a decreased in the active vibration control device 1A, even though not shown, due to the inner hollow cylinder 3 being displaced so as to come away from the outer hollow cylinder 2.

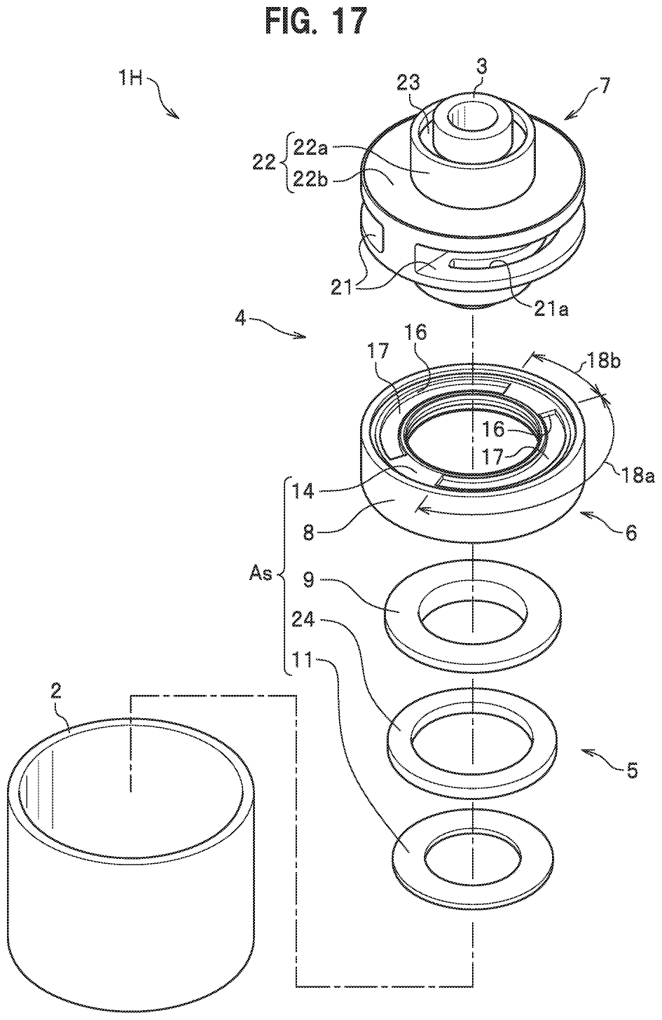

Back to FIG. 6A, when hydraulic pressure of the liquid 20a is increased in the second liquid chamber 21, the bottom wall 17 of the flexible member 14 is pushed in a direction D toward the first liquid chamber 15. Additionally, when hydraulic pressure of the liquid 20a is decreased in the second liquid chamber 21 on the opposite side of the inner hollow cylinder 3, the bottom wall 17 of the flexible member 14 is pulled in a direction opposite to the direction D in FIG. 6A, even though not shown. That is, the bottom wall 17 of the flexible member 14 bends in the active vibration control device 1A so as to be convex toward the first liquid chamber 15, as shown in FIG. 6B. Additionally, the bottom wall 17 on the opposite side of the inner hollow cylinder 3, not shown, bends so as to be convex toward a direction coming away from the first liquid chamber 15. This causes the magneto-viscoelastic fluid 20b in the first liquid chamber 15 to have a flow F flowing through the orifice 15a, as shown in FIG. 16B.

On another front, a magnetic field generated by the energized magnet coil 12 provides the magnetic circuit Mc through the first magnetic circuit provider 8, the second magnetic circuit provider 9, and the third magnetic circuit provider 11, as shown in FIG. 6B. That is, the magnetic circuit Mc is provided through the magneto-viscoelastic fluid 20b in the orifice 15a.

As shown left in FIG. 6C, the magneto-viscoelastic fluid 20b in the orifice 15a of the first liquid chamber 15 has initial fluidity, with the magnetic powder Mp dispersed, when no magnetic field is applied. In contrast, as shown right in FIG. 6C, the magnetic powder Mp is aligned along a magnetic flux ML, when the magnetic circuit Mc (see FIG. 6B) is provided by the generated magnetic field. This increases apparent consistency of the magneto-viscoelastic fluid 20b and causes the aligned magnetic powder Mp to work as valve elements to generate flow resistance in the orifice 15a. The active vibration control device 1A uses this flow resistance of the magneto-viscoelastic fluid 20b in the orifice 15a to accomplish a property of damping inputted vibration and the like. The property of damping vibration and the like can be varied with a current value flowing through the magnet coil 12 controlled in response to the magnitude of inputted vibration and the like.

The active vibration control device 1A of the present embodiment is configured to cause the magneto-viscoelastic fluid 20b to flow in the first liquid chamber 15 in response to changes in hydraulic pressure of the liquid 20a in the second liquid chambers 21, when a load and/or amplitude by vibration is/are inputted from outside to at least one of the inner hollow cylinder 3 and the outer hollow cylinder 2. The active vibration control device 1A controls a property of damping vibration and the like, using magnitude of a magnetic field (magnetic flux density) applied through the orifice 15a of the first liquid chamber 15.

The active vibration control device 1A as described above is different from a conventional active vibration control device (see Patent Document 1, for example), which directly changes vibration and the like inputted from outside into a flow of magneto-viscoelastic fluid, on the point that changes in hydraulic pressure of the liquid 20a in the second liquid chambers 21 cause the magneto-viscoelastic fluid 20b to flow in the first liquid chamber 15. The active vibration control device 1A of the present embodiment allows for improving performance of response to inputted vibration and the like by increasing volume of the second liquid chambers 21 filled with the liquid 20a, without increasing volume of the first liquid chamber 15 filled with the magneto-viscoelastic fluid 20b.

In addition, the active vibration control device 1A is different from a conventional active vibration control device (see Patent Document 1, for example) on the point that a liquid chamber (first liquid chamber 15) filled with the magneto-viscoelastic fluid 20b is comparatively reduced in volume, to allow for using less amount of the magneto-viscoelastic fluid 20b, which is comparatively heavy with the magnetic powder Mp and expensive.

Further, the active vibration control device 1A is different from a conventional active vibration control device (see Patent Document 1, for example) on the point that a liquid chamber (first liquid chamber 15) filled with the magneto-viscoelastic fluid 20b is comparatively reduced in volume, to have less absolute amount of the magnetic powder Mp, which is contained in the magneto-viscoelastic fluid 20b, deposited.

Still further, the active vibration control device 1A has a liquid chamber (first liquid chamber 15), filled with the magneto-viscoelastic fluid 20b, comparatively reduced in volume, to allow the magnetic powder Mp to be redispersed with the deposited magnetic powder Mp being disturbed by the flow F of the magneto-viscoelastic fluid 20b. As preventing the magnetic powder Mp from being deposited with age, the active vibration control device 1A can keep favorable performance of damping vibration and the like.

Still further, the active vibration control device 1A has the first liquid chamber 15, the second liquid chamber 21, and the flexible member 14 extending in a circumferential direction thereof. The active vibration control device 1A as described above can be reduced in size, while keeping favorable performance of response to inputted vibration and the like.

Still further, the active vibration control device 1A has the first-liquid-chamber definer 6 to define the first liquid chamber 15, the second-liquid-chamber definer 7 to define the second liquid chambers 21, and the magnetic field provider 5 having the magnet coil 12 arranged so as to be aligned, in an axis direction of the device, with one another. The active vibration control device 1A as described above allows the liquid 20a in the second liquid chambers 21 to efficiently set off the flow F of the magneto-viscoelastic fluid 20b in the first liquid chamber 15, for vibration and the like inputted from either one of the inner hollow cylinder 3 and the outer hollow cylinder 2.

Still further, in the method of manufacturing the active vibration control device 1A as described above, the step (sealing step) of filling the magneto-viscoelastic fluid in the first liquid chamber 15 (see FIG. 5) is implemented by putting the second magnetic circuit provider 9 (magnetic material), the magnet coil 12, and the third magnetic circuit provider 11 (magnetic material) together with the first magnetic circuit provider 8 (magnetic material), with all of these submerged in liquid of the magneto-viscoelastic fluid.

In a method of manufacturing a conventional active vibration control device (see Patent Document 1, for example), an active vibration control device is first composed in its entirety and then magneto-viscoelastic fluid is filled into a liquid chamber through a predetermined filling hole. Such a conventional manufacturing method has a risk of leaving bubbles in the liquid chamber, to degrade performance of damping vibration and the like. In contrast, in the method of manufacturing the active vibration control device 1A, components of the assembly As are preliminarily put together before the device is composed in its entirety, with all the components submerged in liquid of the magneto-viscoelastic fluid 20b, to have the first liquid chamber 15 filled with the magneto-viscoelastic fluid 20b. The manufacturing method of the present embodiment as described above prevents from leaving bubbles within the magneto-viscoelastic fluid 20b in the first liquid chamber 15.

The active vibration control device 1A as described above can be suitably used in place of a conventional mount bush and suspension bush, each of which needs to be carefully selected based on safety performance, kinetic performance, comfort performance, ride comfort performance, and the like.

### Second Embodiment

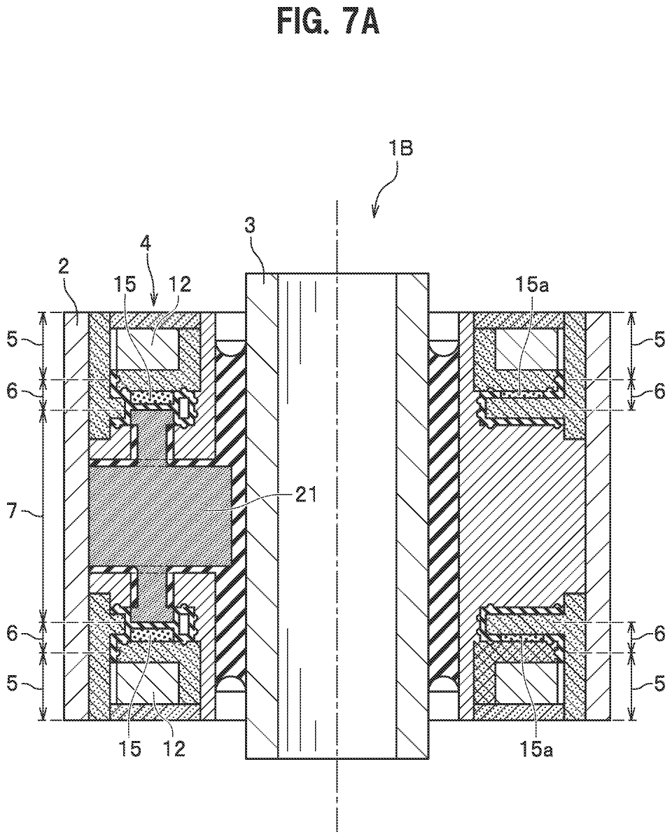

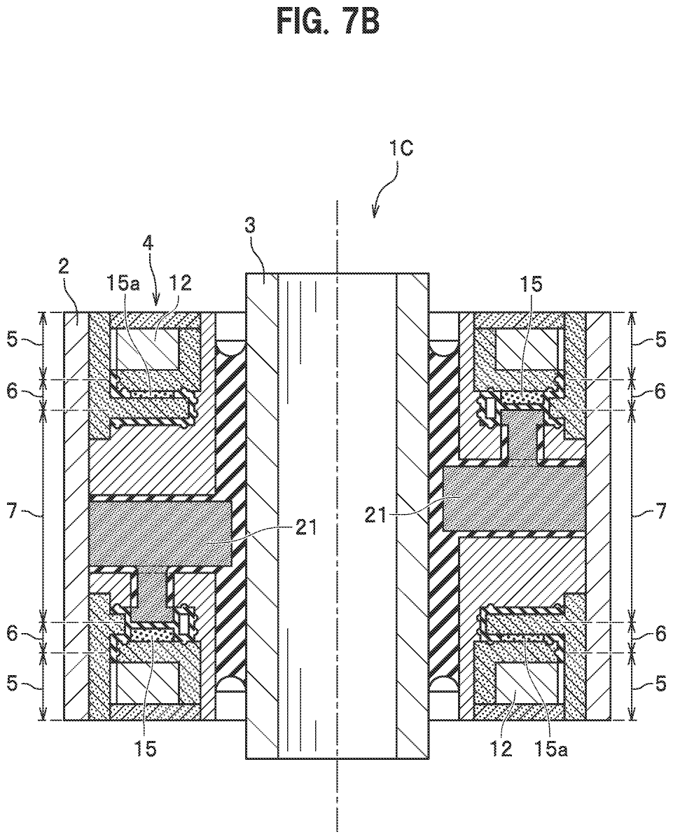

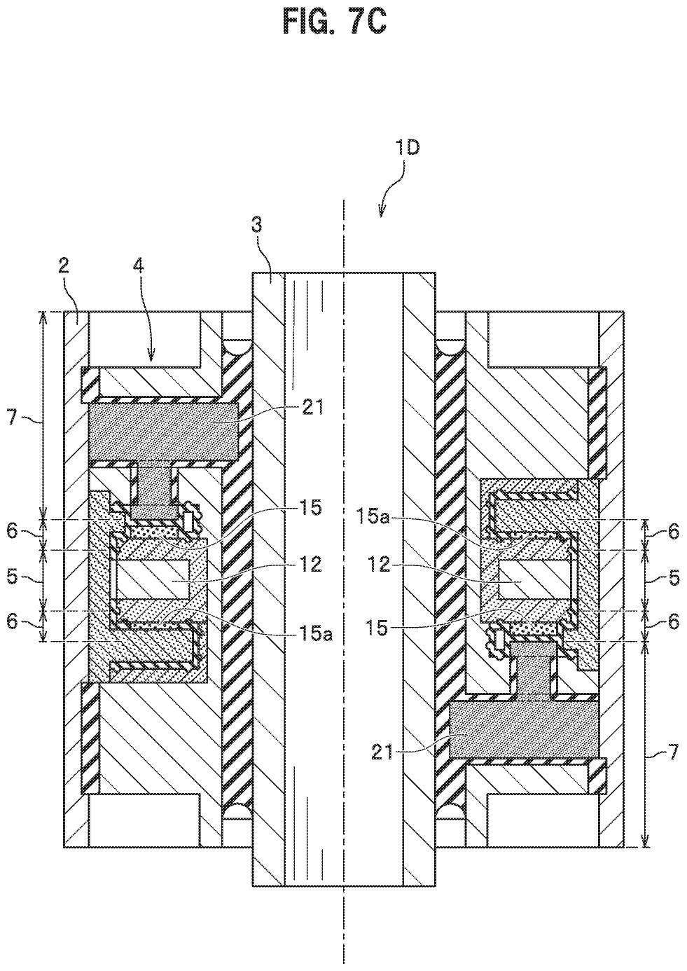

Next, a description is given of an active vibration control device according to a second embodiment of the present invention. FIG. 7A is a cross-sectional view of an active vibration control device 1B according to the second embodiment of the present invention, with a cross section corresponding to that taken along the line IV-IV in FIG. 1B. Note that the same components as the first embodiment are indicated in the present embodiment by the identical reference signs, and detailed descriptions thereof are skipped.

As shown in FIG. 7A, the active vibration control device 1B of the second embodiment is different from the active vibration control device 1A (see FIG. 4) of the first embodiment on the point that there are two or more units (two in the present embodiment) provided in the axis direction, each having the first-liquid-chamber definer 6 to define the first liquid chamber 15, the second-liquid-chamber definer 7 to define the second liquid chambers 21, and the magnetic field provider 5 having the magnet coil 12. The active vibration control device 1B as described above allows for further varying stiffness in the axis direction. Additionally, the active vibration control device 1B has the adjacent units aligned in the axis direction so as to have the second liquid chambers 21 in-between, to share the second liquid chambers 21. This allows the active vibration control device 1B to be reduced in size more effectively.

### Third Embodiment

Next, a description is given of an active vibration control device according to a third embodiment of the present invention. FIG. 7B is a cross-sectional view of an active vibration control device 1C according to the third embodiment of the present invention, with a cross section corresponding to that taken along the line IV-IV in FIG. 1B. Note that the same components as the first embodiment are indicated in the present embodiment by the identical reference signs, and detailed descriptions thereof are skipped.

As shown in FIG. 7B, the active vibration control device 1C of the third embodiment has units, each composed of the first-liquid-chamber definer 6, the second-liquid-chamber definer 7, and the magnetic field provider 5, axially adjacent to each other but arranged so as to be topologically different from each other about the axis. In particular, the active vibration control device 1C has the units arranged so as to be topologically different from each other about the axis by 180 degrees. The active vibration control device 1C as described above allows for varying stiffness in two or more directions orthogonal to the axis, to further improve performance of damping vibration and the like.

### Fourth Embodiment

Next, a description is given of an active vibration control device according to a fourth embodiment of the present invention. FIG. 7C is a cross-sectional view of an active vibration control device 1D according to the fourth embodiment of the present invention, with a cross section corresponding to that taken along the line IV-IV in FIG. 1B. Note that the same components as the first embodiment are indicated in the present embodiment by the identical reference signs, and detailed descriptions thereof are skipped.

As shown in FIG. 7C, the active vibration control device 1D of the fourth embodiment has units, each composed of the first-liquid-chamber definer 6, the second-liquid-chamber definer 7, and the magnetic field provider 5, axially adjacent to each other, and sharing the single magnetic field provider 5. In particular, the active vibration control device 1D has the units arranged so as to have the first-liquid-chamber definer 6 and the second-liquid-chamber definer 7 reversed from each other on both sides in the axis direction of the magnetic field provider 5. Here, the adjacent units may be arranged so as to be topologically different from each other about the axis (e.g., by 180 degrees), as shown in FIG. 7C, or so as to be topologically aligned with each other, even though not shown. The active vibration control device 1D as described above allows for eliminating one of the magnetic field providers 5 of the adjacent units, to simplify the device.

### Fifth Embodiment

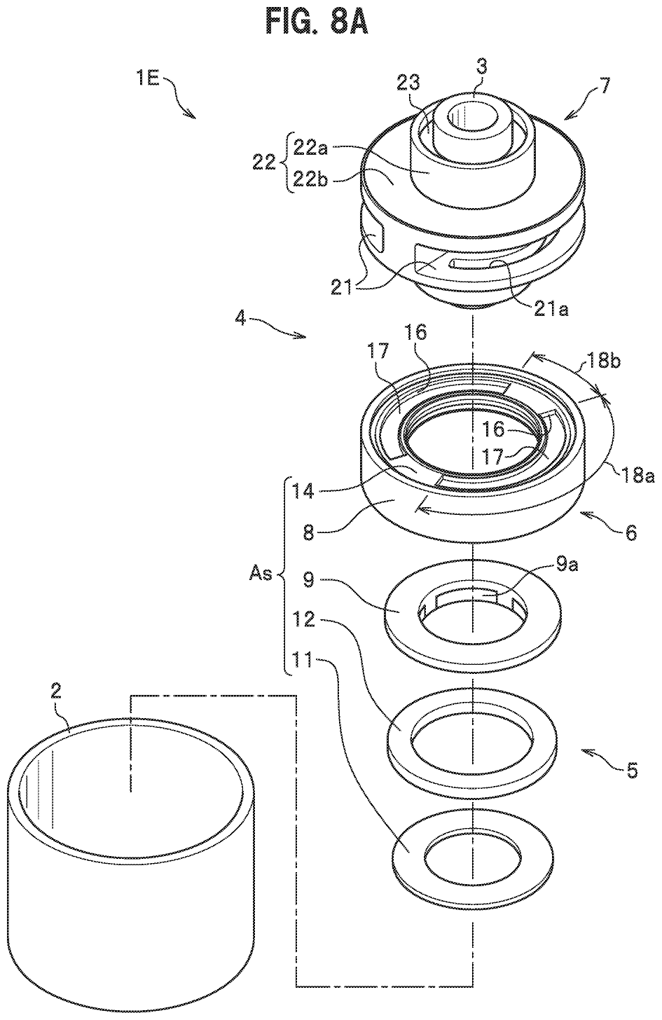

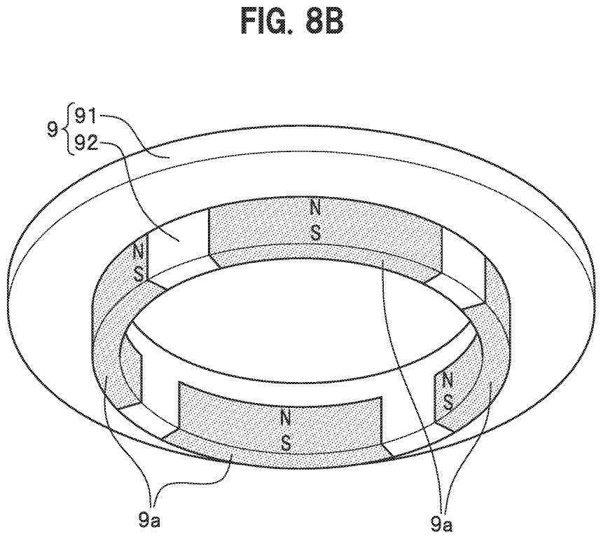

Next, a description is given of an active vibration control device according to a fifth embodiment of the present invention. FIG. 8A is a perspective view of a disassembled active vibration control device 1E according to the fifth embodiment of the present invention, and corresponds to FIG. 3 for the first embodiment. FIG. 8B is a perspective view of the second magnetic circuit provider (magnetic material) indicated by a reference sign 9 in FIG. 8A, as viewed from a point to see a cylindrical portion of the provider. Note that the same components as the first embodiment are indicated in the present embodiment by the identical reference signs, and detailed descriptions thereof are skipped.

As shown in FIG. 8A, the active vibration control device 1E of the fifth embodiment is different from the active vibration control device 1A (see FIG. 3) of the first embodiment on the point that the second magnetic circuit provider 9 (magnetic material) includes a permanent magnet 9a. In particular, the four permanent magnets 9a are arranged in a circumferential direction of the cylindrical portion 92 of the second magnetic circuit provider 9 at equal intervals, as shown in FIG. 8B. Note that the permanent magnets 9a may be built into the cylindrical portion 92 or may be made by the cylindrical portion 92 being directly magnetized. Incidentally, the permanent magnets 9a of the present embodiment are each assumed to have one axial end thereof closer to the ring portion 91 of the second magnetic circuit provider 9 being the north pole and the opposite axial end thereof to the former being the south pole.

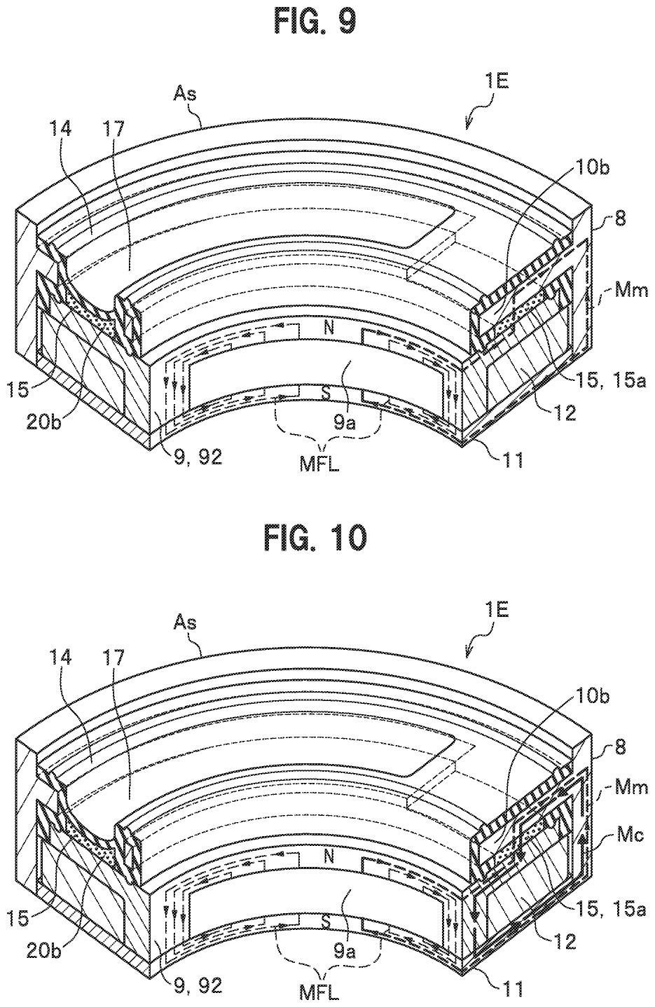

FIG. 9 is a perspective view of the partially-sectioned assembly As (see FIG. 8A) from the first-liquid-chamber definer 6 and the magnetic field provider 5 of the active vibration control device 1E according to the fifth embodiment, and corresponds to FIG. 6B for the first embodiment. Note that FIG. 9 shows a case where no current is applied to the magnet coil 12. As shown in FIG. 9, the assembly As of the active vibration control device 1E has the permanent magnets 9a arranged in the cylindrical portion 92 radially inside the second magnetic circuit provider 9 (magnetic material) adjacent to the magnet coil 12. The cylindrical portion 92 corresponds to a “lateral face” in one or more claims.

### Advantageous Effects

Next, a description is given of advantageous effects of the active vibration control device 1E according to the present embodiment, with behavior of the active vibration control device 1E. As shown in FIG. 9, the permanent magnets 9a of the active vibration control device 1E each generate magnetic fields indicated by magnetic field lines MFL through magnetic materials therearound. In particular, the magnetic fields are generated through the cylindrical portion 92 of the second magnetic circuit provider 9 and an inner periphery portion of the third magnetic circuit provider 11.

Then, when the magnetic materials around the permanent magnets 9a are almost saturated magnetically (saturation magnetic flux density), a magnetic circuit Mm through the orifice 15a is provided by the permanent magnets 9a. In particular, the magnetic circuit Mm is provided across the first magnetic circuit provider 8, the second magnetic circuit provider 9, and the third magnetic circuit provider 11, through the magneto-viscoelastic fluid 20b in the orifice 15a. In other words, the active vibration control device 1E has the permanent magnets 9a providing the magnetic circuit Mm through the orifice 15a.

FIG. 10 is a perspective view of the partially-sectioned assembly As, with the magnetic circuit Mc through the orifice 15a provided by the magnetic coil 12 due to a current having been applied to the magnetic coil 12. As shown in FIG. 10, the active vibration control device 1E has the magnetic circuit Mc provided due to the magnetic field generated by the energized magnet coil 12 across the first magnetic circuit provider 8, the second magnetic circuit provider 9, and the third magnetic circuit provider 11, as with the first embodiment (see FIG. 6B). That is, the magnetic circuit Mc is provided through the magneto-viscoelastic fluid 20b in the orifice 15a. Incidentally, a current is applied to the magnet coil 12 in the present embodiment so as to generate a reversed magnetic field with respect to an orientation of the magnetic field through the orifice 15a generated by the permanent magnets 9a.

That is, the magnetic field through the orifice 15a generated by the permanent magnets 9a is canceled or weakened in the active vibration control device 1E, by the magnetic field through the orifice 15a generated by the magnet coil 12. The active vibration control device 1E is different from the active vibration control device 1A (see FIG. 6B) of the first embodiment, having stiffness increased by applying a current to the magnet coil 12, on the point that stiffness is decreased by applying a current to the magnet coil 12.

The active vibration control device 1E as described above has the magneto-viscoelastic fluid 20b in the orifice 15a keeping high viscosity due to the magnetic field generated by the permanent magnets 9a. This allows for securing desired damping property and stiffness of the device, even in non-energized condition where no current is applied to the magnet coil 12.

In addition, the active vibration control device 1E can decrease stiffness thereof by applying a current to the magnet coil 12, as described above, which is different from a conventional case, to improve degree of freedom when damping property and/or stiffness thereof is/are varied.

Further, the active vibration control device 1E can keep density of the magnetic powder Mp high in the magneto-viscoelastic fluid 20b in the orifice 15a, due to the magnetic field through the orifice 15a generated by the permanent magnets 9a. This allows for preventing the magnetic powder Mp from being deposited, when the device is applied to a part having a short stroke and having the magneto-viscoelastic fluid 20b less likely stirred, such as a mount bush of an engine. Accordingly, the active vibration control device 1E improves performance of response to vary viscosity of the magneto-viscoelastic fluid 20b by applying a current to the magnet coil 12.

Still further, the active vibration control device 1E can also apply a current to the magnet coil 12 so as to set an orientation of a magnetic field through the orifice 15a to be generated by the magnet coil 12 equal to that of a magnetic field through the orifice 15a generated by the permanent magnet 9a. The active vibration control device 1E as described above can further increase a planned range of variation in damping property and/or stiffness thereof.

### Sixth Embodiment

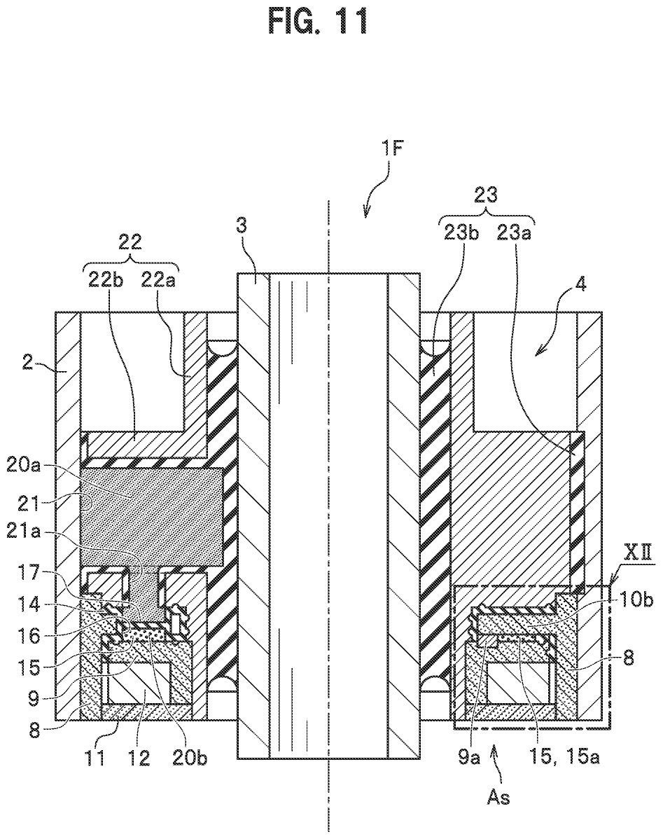

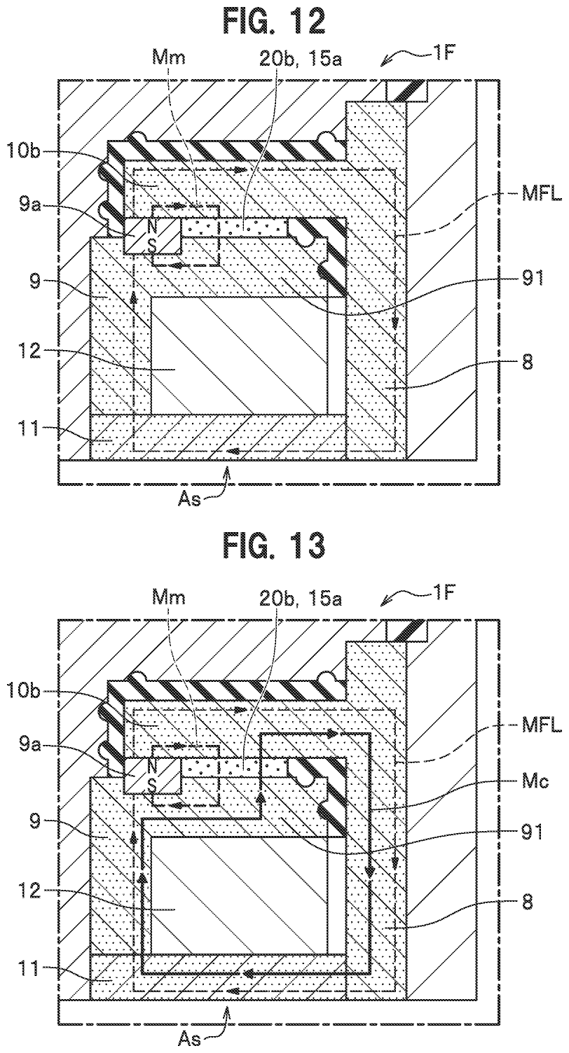

Next, a description is given of an active vibration control device according to a sixth embodiment of the present invention. FIG. 11 is a cross-sectional view of an active vibration control device 1F according to a sixth embodiment of the present invention, and corresponds to FIG. 4 for the first embodiment. FIG. 12 is a partially-enlarged cross-sectional view of the assembly As at a portion XII in FIG. 11. Note that the same components as the first embodiment are indicated in the present embodiment by the identical reference signs, and detailed descriptions thereof are skipped.

As shown in FIG. 11, the active vibration control device 1F of the sixth embodiment is different from the active vibration control device 1A (see FIG. 3) of the first embodiment on the point that the permanent magnet 9 is arranged in the magnetic material so as to be adjacent to a radially inner end of the orifice 15a. In particular, the permanent magnet 9a is arranged between the flange 10b of the first magnetic circuit provider 8 and the ring portion 91 of the second magnetic circuit provider 9. The permanent magnet 9a magnetically connects the first magnetic circuit provider 8 with the second magnetic circuit provider 9. Note that the permanent magnet 9a is arranged to scale with the circumferentially-extending orifice 15a, even though not shown, at an inner periphery of the orifice 15a. Incidentally, the permanent magnet 9a of the present embodiment is assumed to have one axial end thereof contacting the second magnetic circuit provider 9 being the south pole and the other axial end thereof contacting the first magnetic circuit provider 8 being the north pole, as shown in FIG. 12.

### Advantageous Effects

Next, a description is given of advantageous effects of the active vibration control device 1F according to the present embodiment, with behavior of the active vibration control device 1F. As shown in FIG. 12, the permanent magnet 9 of the active vibration control device 1F generates a magnetic field indicated by the magnetic field line MFL through magnetic materials therearound. In particular, the magnetic field is generated across the first magnetic circuit provider 8, the third magnetic circuit provider 11, and the second magnetic circuit provider 9. Note that FIG. 12 shows a case where no current is applied to the magnet coil 12.

Then, when the magnetic materials around the permanent magnet 9a are almost saturated magnetically (saturation magnetic flux density), the magnetic circuit Mm through the orifice 15a is provided by the permanent magnet 9a. In particular, the magnetic circuit Mm is provided across the flange 10b of the first magnetic circuit provider 8, the magneto-viscoelastic fluid 20b in the orifice 15a, and the ring portion 91 of the second magnetic circuit provider 9, with the permanent magnet 9a interposed therein. In other words, the active vibration control device 1F has the orifice 15a, through which the magnetic circuit Mm is provided by the permanent magnet 9a.

FIG. 13 is a partially-enlarged cross-section view of the assembly As, with the magnetic circuit Mc through the orifice 15a provided by the magnetic coil 12, due to a current having been applied to the magnet coil 12. As shown in FIG. 13, the active vibration control device 1F has the magnetic circuit Mc provided due to the magnetic field generated by the energized magnet coil 12 across the first magnetic circuit provider 8, the second magnetic circuit provider 9, and the third magnetic circuit provider 11. That is, the magnetic circuit Mc is provided through the magneto-viscoelastic fluid 20b in the orifice 15a. Incidentally, a current is applied to the magnet coil 12 in the present embodiment so as to generate a reversed magnetic field with respect to an orientation of the magnetic field through the orifice 15a generated by the permanent magnet 9a.

The magnetic field through the orifice 15a generated by the permanent magnet 9a is canceled or weakened in the active vibration control device 1F, by the magnetic field through the orifice 15a generated by the magnet coil 12. The active vibration control device 1F has stiffness thereof decreased by applying a current to the magnet coil 12, as with the active vibration control device 1E (see FIG. 10) of the fifth embodiment.

The active vibration control device 1F as described above achieves the same advantageous effects as those of the active vibration control device 1E (see FIG. 10) of the fifth embodiment. Additionally, the active vibration control device 1F has the permanent magnet 9a arranged closer to the orifice 15a, as compared with the active vibration control device 1E (see FIG. 10) of the fifth embodiment. This allows the active vibration control device 1F to generate a magnetic field through the orifice 15a by the permanent magnet 9a more effectively.

### Seventh Embodiment

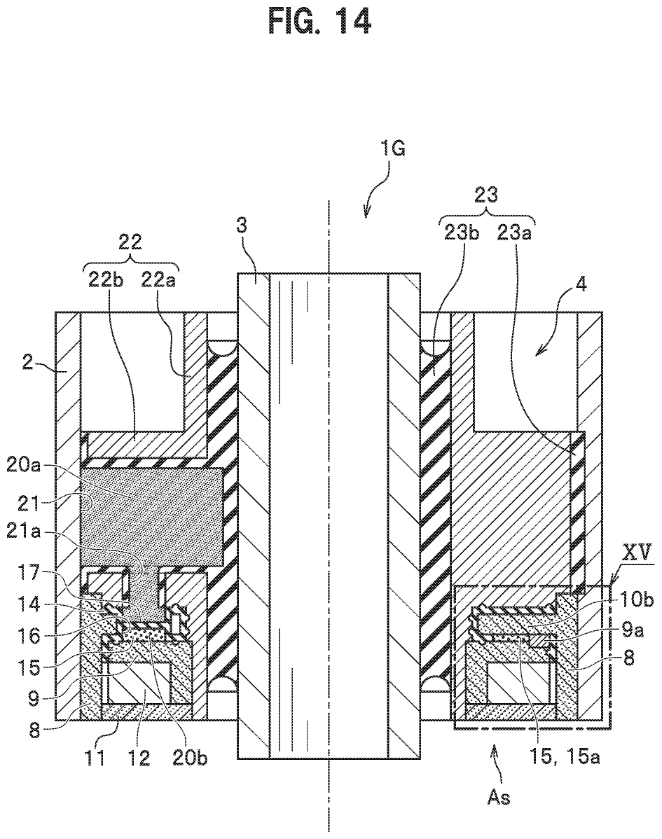

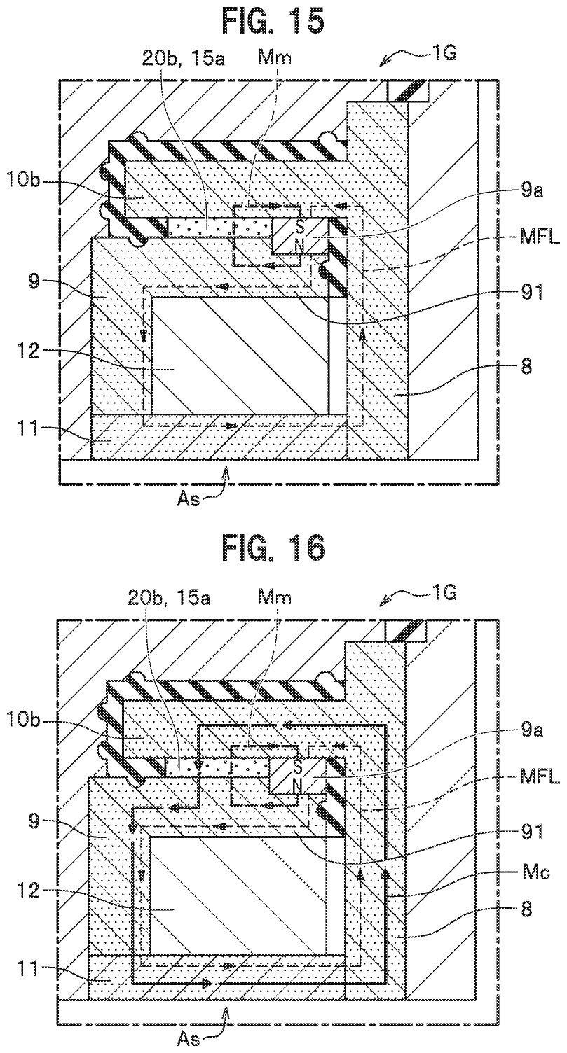

Next, a description is given of an active vibration control device according to a seventh embodiment of the present invention. FIG. 14 is a cross-sectional view of an active vibration control device 1G according to the seventh embodiment of the present invention, and corresponds to FIG. 4 for the first embodiment. FIG. 15 is a partially-enlarged cross-sectional view of the assembly As at a portion XV in FIG. 14. Note that the same components as the first embodiment are indicated in the present embodiment by the identical reference signs, and detailed descriptions thereof are skipped.

As shown in FIG. 14, the active vibration control device 1G of the seventh embodiment is different from the active vibration control device 1A (see FIG. 3) of the first embodiment on the point that the permanent magnet 9 is arranged in the magnetic material so as to be adjacent to a radially outer end of the orifice 15a. In particular, the permanent magnet 9a is arranged between the flange 10b of the first magnetic circuit provider 8 and the ring portion 91 of the second magnetic circuit provider 9. The permanent magnet 9a magnetically connects the first magnetic circuit provider 8 with the second magnetic circuit provider 9. Note that the permanent magnet 9a is arranged to scale with the circumferentially-extending orifice 15a, even though not shown, at an outer periphery of the orifice 15a. Incidentally, the permanent magnet 9a of the present embodiment is assumed to have one axial end thereof contacting the second magnetic circuit provider 9 being the north pole and the other axial end thereof contacting the first magnetic circuit provider 8 being the south pole, as shown in FIG. 15.

### Advantageous Effects

Next, a description is given of advantageous effects of the active vibration control device 1G according to the present embodiment, with behavior of the active vibration control device 1G. As shown in FIG. 15, the permanent magnet 9 of the active vibration control device 1G generates a magnetic field indicated by the magnetic field line MFL through magnetic materials therearound. In particular, the magnetic field is generated across the first magnetic circuit provider 8, the third magnetic circuit provider 11, and the second magnetic circuit provider 9. Note that FIG. 15 shows a case where no current is applied to the magnet coil 12.

Then, when the magnetic materials around the permanent magnet 9a are almost saturated magnetically (saturation magnetic flux density), the magnetic circuit Mm through the orifice 15a is provided by the permanent magnet 9a. In particular, the magnetic circuit Mm is provided across the flange 10b of the first magnetic circuit provider 8, the magneto-viscoelastic fluid 20b in the orifice 15a, and the ring portion 91 of the second magnetic circuit provider 9, with the permanent magnet 9a interposed therein. In other words, the active vibration control device 1G has the orifice 15a, through which the magnetic circuit Mm is provided by the permanent magnet 9a.

FIG. 16 is a partially-enlarged cross-section view of the assembly As, with the magnetic circuit Mc through the orifice 15a provided by the magnetic coil 12, due to a current having been applied to the magnet coil 12. As shown in FIG. 16, the active vibration control device 1G has the magnetic circuit Mc provided due to the magnetic field generated by the energized magnet coil 12 across the first magnetic circuit provider 8, the second magnetic circuit provider 9, and the third magnetic circuit provider 11. That is, the magnetic circuit Mc is provided through the magneto-viscoelastic fluid 20b in the orifice 15a. Incidentally, a current is applied to the magnet coil 12 in the present embodiment so as to generate a reversed magnetic field with respect to an orientation of the magnetic field through the orifice 15a generated by the permanent magnet 9a.

The magnetic field through the orifice 15a generated by the permanent magnet 9a is canceled or weakened in the active vibration control device 1G, by the magnetic field through the orifice 15a generated by the magnet coil 12. The active vibration control device 1G has stiffness thereof decreased by applying a current to the magnet coil 12, as with the active vibration control device 1E (see FIG. 10) of the fifth embodiment.

The active vibration control device 1G as described above achieves the same advantageous effects as those of the active vibration control device 1E (see FIG. 10) of the fifth embodiment. Additionally, the active vibration control device 1G has the permanent magnet 9a arranged closer to the orifice 15a, as compared with the active vibration control device 1E (see FIG. 10) of the fifth embodiment. This allows the active vibration control device 1G to generate a magnetic field through the orifice 15a by the permanent magnet 9a more effectively.

In addition, the permanent magnet 9a of the active vibration control device 1G is arranged on a radially outer side of the orifice 15a, to have a longer circumferential length, as compared with the permanent magnet 9a of the active vibration control device 1F (see FIG. 11) of the sixth embodiment arranged on the radially inner side of the orifice 15a. This allows the active vibration control device 1G to generate a magnetic field through the orifice 15a by the permanent magnet 9a further effectively, as compared with the active vibration control device 1F (see FIG. 11).

### Eighth Embodiment

Next, a description is given of an active vibration control device according to an eighth embodiment of the present invention. FIG. 17 is a perspective view of the disassembled active vibration control device 1H according to the eighth embodiment of the present invention, and corresponds to FIG. 3 for the first embodiment. Note that the same components as the first embodiment are indicated in the present embodiment by the identical reference signs, and detailed descriptions thereof are skipped.

As shown in FIG. 17, the active vibration control device 1H of the eighth embodiment is different from the active vibration control device 1A (see FIG. 3) of the first embodiment on the point that it includes a permanent magnet 24 in place of the magnet coil 12.

### Advantageous Effects

In a case where the active vibration control device 1H is moved a little to have the bottom wall 17 of the flexible member 14 not deformed noticeably, hydraulic pressure of the magneto-viscoelastic fluid 20b flowing through the orifice 15a is low. Meanwhile, the active vibration control device 1H used in such a condition may have the permanent magnet 24 constantly generating a magnetic field through the orifice 15a (see FIG. 4).

As a result, the active vibration control device 1H has the magnetic powder Mp aligned along the magnetic flux ML by the generated magnetic field, as shown right in FIG. 6C. This increases apparent consistency of the magneto-viscoelastic fluid 20b and causes the aligned magnetic powder Mp to work as valve elements to generate flow resistance in the orifice 15a. The active vibration control device 1H transitions into a stiff state.

When hydraulic pressure of the magneto-viscoelastic fluid 20b becomes equal to or greater than a certain level, the active vibration control device 1H fails to keep magnetic powder Mp aligned. The active vibration control device 1H transitions into a flexible state. The active vibration control device 1H as described above is capable of switching between two stiffness levels in proportion to a level of a load inputted to the active vibration control device 1H, even without control of a magnetic field by the magnet coil 12.

### Ninth Embodiment

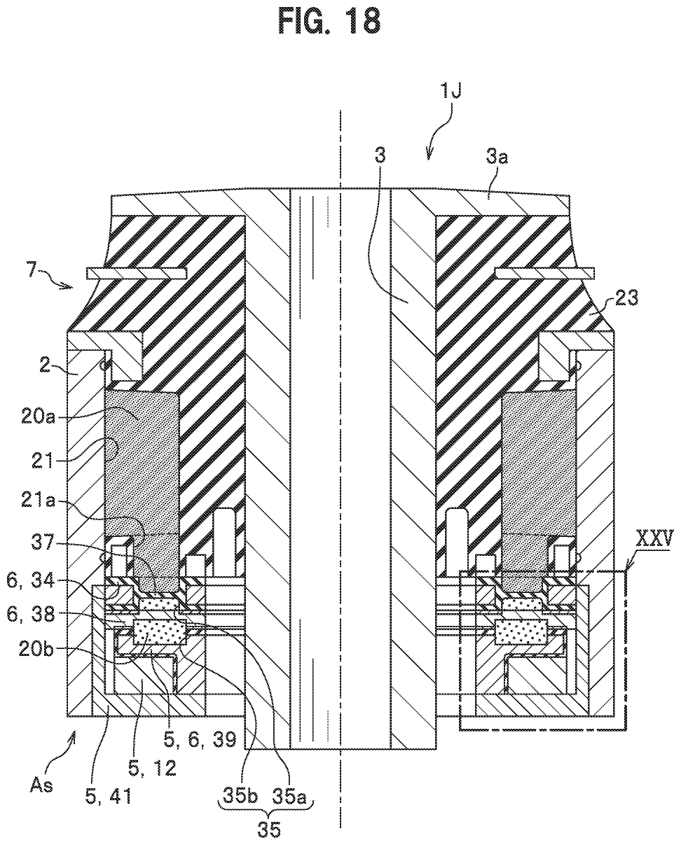

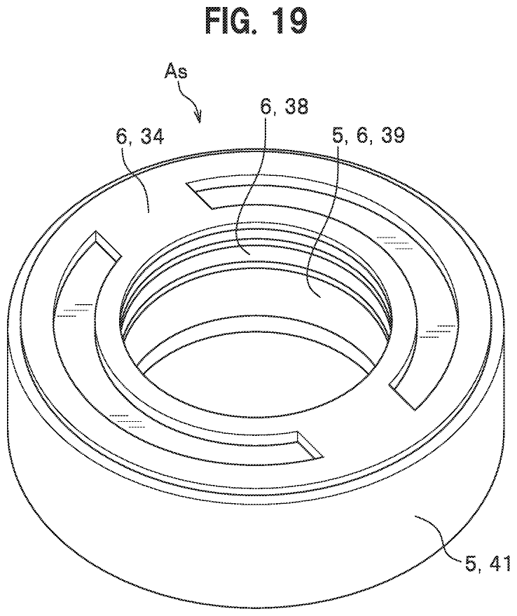

Next, a description is given of an active vibration control device according to a ninth embodiment of the present invention. FIG. 18 is a cross-sectional view of an active vibration control device 1J according to the ninth embodiment of the present invention. Note that the same components as the first embodiment are indicated in the present embodiment by the identical reference signs, and detailed descriptions thereof are skipped. As shown in FIG. 18, the active vibration control device 1J is different from the active vibration control device 1A (see FIG. 2) of the first embodiment on the point that it has a flange 3a at an end in the axis direction of the inner hollow cylinder 3. In addition, the active vibration control device 1J does not have the liquid chamber definer 22 (see FIG. 3) in a substantially peg-top shape, which is made of a non-magnetic material and included in the second-liquid-chamber definer 7 (see FIG. 3) of the active vibration control device 1A (see FIG. 3).

Further, the active vibration control device 1J includes the elastic support 23 composed of an elastic body in a substantially cylindrical shape, which is bonded by way of vulcanization to a surface of the flange 3a, having an inside corner with the inner hollow cylinder 3, and an outer periphery of the inner hollow cylinder 3, as shown in FIG. 18, to compensate for the liquid chamber definer 22 (see FIG. 3). The second liquid chamber 21 of the active vibration control device 1J is defined, with the elastic support 23 partly removed in the circumferential direction to open to the outer hollow cylinder 2 from radially inside.

The second-liquid-chamber definer 7 having the elastic support 23 as described above defines the pair of the second liquid chamber 21 extending in the circumferential direction between the outer hollow cylinder 2 and the inner hollow cylinder 3, as with the second liquid chambers 21 (see FIG. 3) of the active vibration control device 1A (see FIG. 3).

Next, a description is given of the first-liquid-chamber definer 6 (see FIG. 18) and the magnetic field provider 5 (see FIG. 18) of the active vibration control device 1J. As shown in FIG. 18, the first-liquid-chamber definer 6 includes a flexible member 34, a first magnetic circuit provider 38, and a second magnetic circuit provider 39 doubling as a part of the magnetic field provider 5. The first-liquid-chamber definer 6 defines a first liquid chamber 35 to seal the magneto-viscoelastic fluid 20b, as shown in FIG. 18.

The first liquid chamber 35 includes an adjacent liquid chamber 35a provided so as to be adjacent to the flexible member 34, and a juxtaposed liquid chamber 35b shifted away from the second liquid chambers 21 than the adjacent liquid chamber 35a. Note that the juxtaposed liquid chamber 35b corresponds to the orifice 15a (see FIG. 6A) of the active vibration control device 1A (see FIG. 6A) of the first embodiment, and works as a flow path of the magneto-viscoelastic fluid 20b.

The magnetic field provider 5 includes the second magnetic circuit provider 39, the magnet coil 12 (magnetic field generator), and a third magnetic circuit provider 41, as shown in FIG. 18. The magnetic field provider 5 provides the magnetic circuit Mc through the juxtaposed liquid chamber 35b, as will be described below.

FIG. 19 is an overall perspective view of the assembly As having the first liquid chamber definer 6 integrated with the magnetic field provider 5. As shown in FIG. 19, the assembly As has a substantially cylindrical shape so as to be fitted radially inside the outer hollow cylinder 2 (see FIG. 18). In FIG. 19, the reference sign 34 indicates the flexible member of the first-liquid-chamber definer 6, the reference sign 38 indicates the first magnetic circuit provider (partition wall) of the first-liquid-chamber definer 6, and the reference sign 39 indicates the second magnetic circuit provider used as the magnetic field provider 5 doubling as the first liquid chamber definer 6. The reference sign 41 indicates the third magnetic circuit provider of the magnetic field provider 5. Note that the magnet coil 12 (see FIG. 18) is not shown in FIG. 19 for the purpose of illustration.

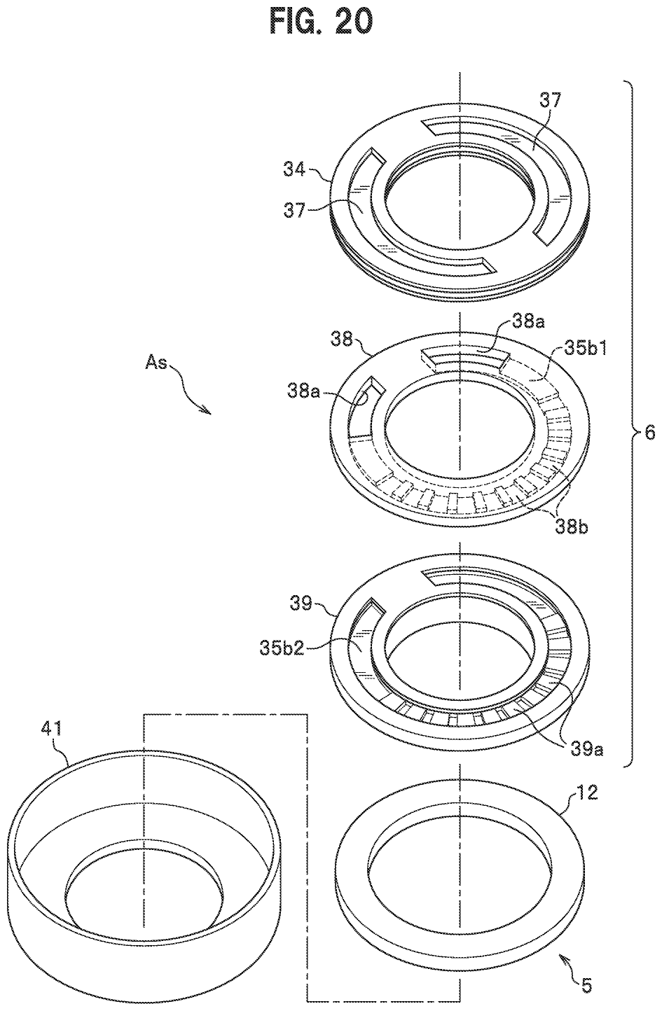

FIG. 20 is a perspective view of the disassembled assembly As. As shown in FIG. 20, the third magnetic circuit provider 41 of the assembly As includes a bottom plate having a center hole, and a cylindrical sidewall. The assembly As has the magnet coil 12 (magnetic field generator) in a ring shape, the second magnetic circuit provider 39, the first magnetic circuit provider 38 (partition wall), and the flexible member 34 superimposed in this order and fitted radially inside the third magnetic circuit provider 41 made of a substantially bottomed hollow cylinder.

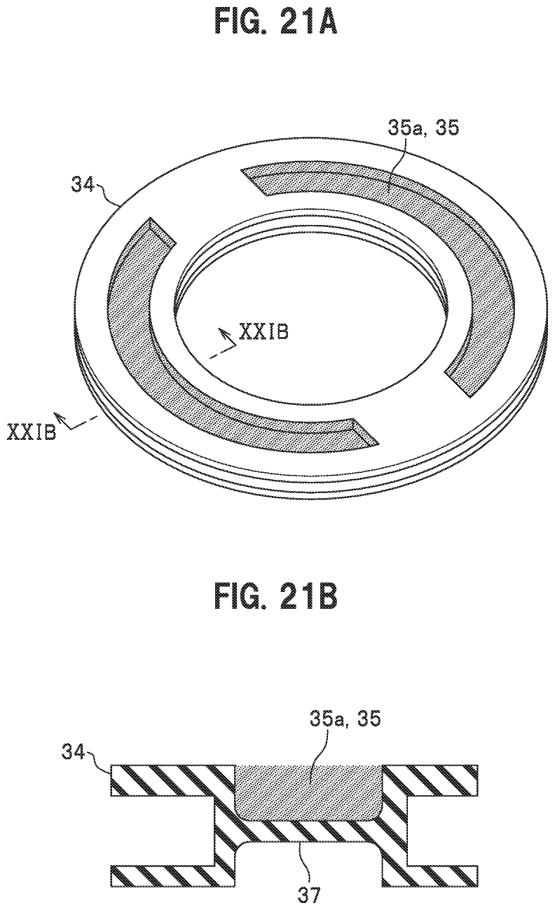

The flexible member 34 is provided, on a top surface thereof, with a pair of bottom walls 37 in an arc shape, which are each similar to the bottom wall 17 (see FIG. 3) of the flexible member 14 (see FIG. 3) of the active vibration control device 1A (see FIG. 3) according to the first embodiment. FIG. 21A is an overall perspective view of the flexible member 34, as viewed from the bottom. FIG. 21B is a cross-sectional view of the flexible member 34, taken along a line XXIb-XXIb in FIG. 21A.

As shown in FIGS. 21A and 21B, the flexible member 34 has the top surface and a bottom surface thereof being mirror-symmetrical to each other. The flexible member 34 is formed in the bottom surface with the groove-like adjacent liquid chamber 35a so as to be mirror-symmetrical to a groove-like concave in the top surface, having the bottom wall 37 (see FIG. 21B). The adjacent liquid chamber 35a seals therein the magneto-viscoelastic fluid 20b (see FIG. 18), with the bottom surface of the flexible member 34 closely attached to the top surface of the first magnetic circuit provider 38 (see FIG. 20).

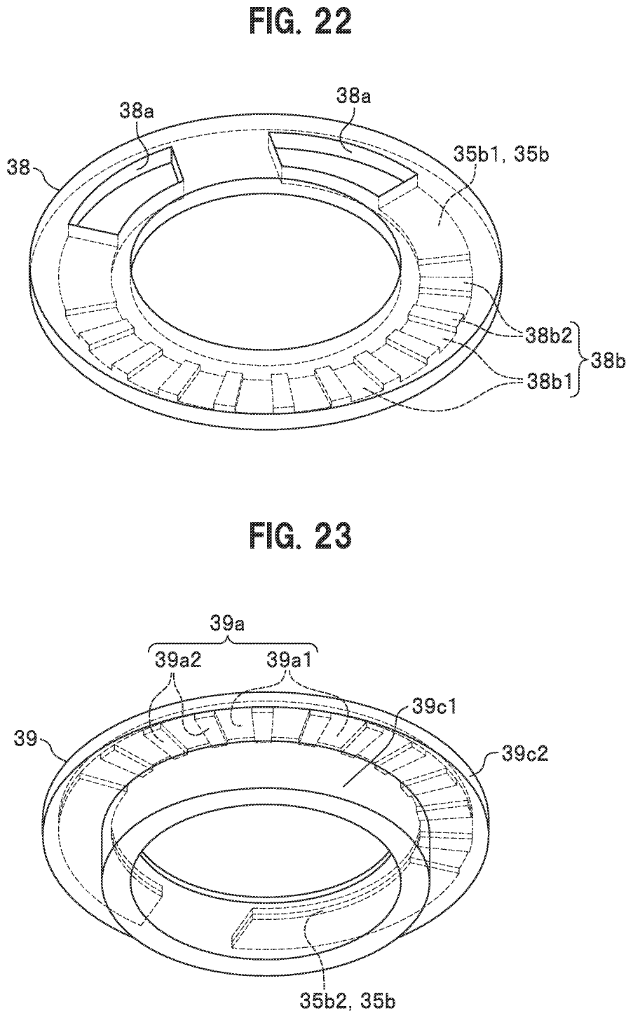

FIG. 22 is an overall perspective view of the first magnetic circuit provider 38, as viewed from the top. Note that a top half 35b1 of the juxtaposed liquid chamber 35b, formed in a bottom surface of the first magnetic circuit provider 38, and a concavo-convex surface 38b, formed in the juxtaposed liquid chamber 35b, are indicated by hidden lines (dotted lines) in FIG. 22.

The first magnetic circuit provider 38 is formed of a plate body in a ring shape, as shown in FIG. 22. The first magnetic circuit provider 38 is formed with a pair of communication paths 38a so as to penetrate, in a through-thickness direction of, the first magnetic circuit provider 38. The pair of communication paths 38a respectively communicate with circumferential end portions of the pair of the adjacent liquid chambers 35a (see FIG. 21A) defined between the first magnetic circuit provider 38 and the flexible member 34 (see FIG. 21A). The communication path 38a (see FIG. 22) has a short arc shape in a planar view so as to match with the circumferential end portion of one of the pair of the adjacent liquid chambers 35a (see FIG. 21A) of the flexible member 34 (see FIG. 21A), facing that of the other of the pair.

The first magnetic circuit provider 38 is formed, in the bottom surface thereof, with the top half 35b1 of the juxtaposed liquid chamber 35b, as shown in FIG. 22. The top half 35b1 is formed of a groove open to the second magnetic circuit provider 39 in FIG. 20. The top half 35b1 extends from one of the pair of the communication paths 38a opposite in direction to the other of the pair of the communication paths 38a, in a circumferential direction of the first magnetic circuit provider 38, connecting to the other of the pair of the communication paths 38a, as shown in FIG. 22. That is, the communication path 38a (see FIG. 22) connects the adjacent liquid chamber 35a (see FIG. 21A) with the juxtaposed liquid chamber 35b (see FIG. 22).

Note that the communication path 38a (see FIG. 22) is preferably formed so as to be positioned higher than a bottom in a vertical direction of the juxtaposed liquid chamber 35b (see FIG. 22), when arranged to have an axis of the active vibration control device 1J (see FIG. 18) horizontal, as will be described in detail below.

The top half 35b1 is formed, in a groove bottom thereof, with the concavo-convex surface 38b circumferentially having a convex portion 38b1, convex toward the second magnetic circuit provider 39, alternating with a concave portion 38b2, concave toward the second magnetic circuit provider 39. The first magnetic circuit provider 38 as described above is arranged so as to partition the first liquid chamber 35 into the adjacent liquid chamber 35a and the juxtaposed liquid chamber 35b, as shown in FIG. 18. The first magnetic circuit provider 38 corresponds to the “partition wall” in one or more claims.

FIG. 23 is an overall perspective view of the second magnetic circuit provider 39, as viewed from the bottom. Note that a bottom half 35b2 of the juxtaposed liquid chamber 35b, formed in a top surface of the second magnetic circuit provider 39, and a concavo-convex surface 39a, formed in the juxtaposed liquid chamber 35b, are indicated by hidden lines (dotted lines) in FIG. 23. The second magnetic circuit provider 39 includes a cylindrical portion 39c1, and a ring portion 39c2 connected to axially one end of the cylindrical portion 39c1 in a flange shape, as shown in FIG. 23.

The bottom half 35b2 of the juxtaposed liquid chamber 35b is formed in a surface of the ring portion 39c2. The bottom half 35b2 is formed in a groove portion in FIG. 20, open to the first magnetic circuit provider 38. The bottom half 35b2 is formed so as to correspond to the top half 35b1 of the first magnetic circuit provider 38, as shown in FIG. 20. The bottom half 35b2 as described above is formed, in a groove bottom thereof, with the concavo-convex surface 39a. The concavo-convex surface 39a circumferentially has a convex portion 39a1, convex toward the first magnetic circuit provider 38 (see FIG. 20), alternating with a concave portion 39a2, concave toward the first magnetic circuit provider 38, as shown in FIG. 23.

As shown in FIG. 20, the top half 35b1 of the first magnetic circuit provider 38 is united with the bottom half 35b2 of the second magnetic circuit provider 39, to define the juxtaposed liquid chamber 35b in FIG. 18. Here, the convex portion 38b1 of the first magnetic circuit provider 38 in FIG. 22 faces the convex portion 39a1 of the second magnetic circuit provider 39 in FIG. 23 at a predetermined clearance. The clearance (gap) between the convex portion 38b1 and the convex portion 39a1 defines an orifice in the juxtaposed liquid chamber 35b as a flow path of the magneto-viscoelastic fluid 20b. That is, the juxtaposed liquid chamber 35b has two or more orifices in a longitudinal (circumferential) direction thereof.

### Advantageous Effects

Next, a description is given of advantageous effects of the active vibration control device 1J (see FIG. 18), with behavior of the first liquid chamber definer 6 (see FIG. 20). When a load has been inputted via, in a direction orthogonal to the axis of, the inner hollow cylinder 3 in FIG. 18, hydraulic pressure of the liquid 20a increases in one of the pair of the second liquid chambers 21, which is compressed between the outer hollow cylinder 2 and the inner hollow cylinder 3. Meanwhile, hydraulic pressure of the liquid 20a decreases in the other of the pair of the second liquid chambers 21, on the opposite side of the inner hollow cylinder 3 to said one of the pair of the second liquid chambers 21.

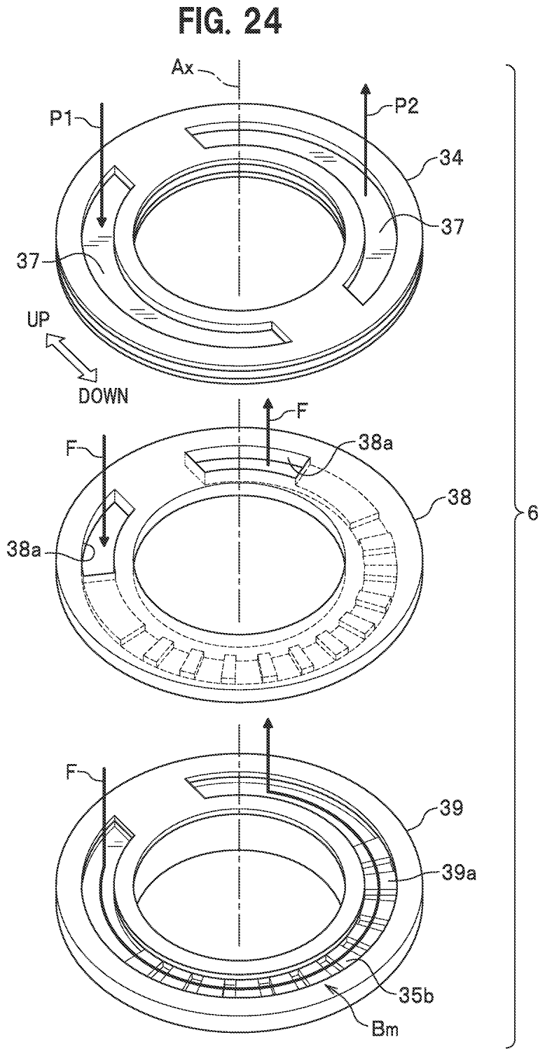

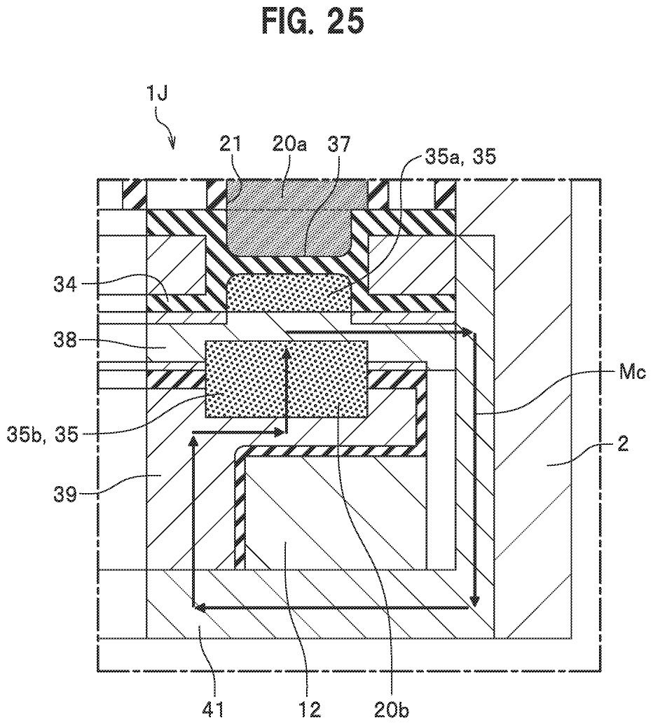

That is, as shown in FIG. 24 illustrating behavior of the first liquid chamber definer 6, a load P1 is inputted to, in a direction of pushing, the bottom wall 37 of the flexible member 34 adjacent to one of the pair of the second liquid chambers 21 (see FIG. 18). The bottom wall 37 is bent so as to be convex toward the adjacent liquid chamber 35a, even though not shown. Meanwhile, as shown in FIG. 24, a load P2 is inputted to, in a direction of pulling, the bottom wall 37 of the flexible member 34 adjacent to the other of the pair of the second liquid chambers 21 (see FIG. 18). The bottom wall 37 is bent so as to be concave toward the adjacent liquid chamber 35a, even though not shown.

This increases hydraulic pressure of the magneto-viscoelastic fluid 20b (see FIG. 18) in one of the adjacent liquid chambers 35a (see FIG. 18), having the bottom wall 37 (see FIG. 18) bent so as to be convex. Meanwhile, this decreases hydraulic pressure of the magneto-viscoelastic fluid 20b (see FIG. 18) in the other of the adjacent liquid chambers 35a (see FIG. 18), having the bottom wall 37 (see FIG. 18) bent so as to be concave. The magneto-viscoelastic fluid 20b (see FIG. 18) in one of the adjacent liquid chambers 35a (see FIG. 18) flows to the other of the adjacent liquid chambers 35a (see FIG. 18). That is, the magneto-viscoelastic fluid 20b (see FIG. 18) has the flow F from one of the communication paths 38a round about the juxtaposed liquid chamber 35b to the other of the communication paths 38a, as shown in FIG. 24.

In addition, as shown in FIG. 25 as a partially enlarged cross-sectional view of a section XXV in FIG. 18, a magnetic field generated by the energized magnet coil 12 provides the magnetic circuit Mc through the juxtaposed liquid chamber 35b. This causes the magneto-viscoelastic fluid 20b in the juxtaposed liquid chamber 35b to increase apparent consistency and generate flow resistance in the juxtaposed liquid chamber 35b. The active vibration control device 1J uses this flow resistance of the magneto-viscoelastic fluid 20b in the juxtaposed liquid chamber 35b to accomplish a property of damping inputted vibration and the like. The property of damping inputted vibration and the like can be varied with a current value flowing through the magnet coil 12 controlled in response to the magnitude of inputted vibration and the like.

Further, the active vibration control device 1J has the adjacent liquid chamber 35a and the juxtaposed liquid chamber 35b, which comprise the first liquid chamber 35, partitioned, in the axis direction thereof, from each other by the first magnetic circuit provider 38 (partition wall), as shown in FIG. 18. Additionally, the adjacent liquid chamber 35a communicates with the juxtaposed liquid chamber 35b, as a flow path of the magneto-viscoelastic fluid 20b, via the communication paths 38a formed in the first magnetic circuit provider 38 (partition wall). The active vibration control device 1J as described above has the magneto-viscoelastic fluid 20b flowing through the juxtaposed liquid chamber 35b axially shifted with respect to the adjacent liquid chamber 35a.

This allows the active vibration control device 1J to have less influence from the magnetic powder in the magneto-viscoelastic fluid 20b being deposited in the juxtaposed liquid chamber 35b, through which the magnetic circuit Mc is provided.

Still further, the active vibration control device 1J has the communication path 38a formed so as to be positioned higher than a bottom Bm in a vertical direction (an up-down direction indicated by an open arrow in FIG. 24) of the juxtaposed liquid chamber 35b (flow path of the magneto-viscoelastic fluid), as shown in FIG. 24, when arranged to have an axis Ax thereof horizontal. The active vibration control device 1J as described above causes the magneto-viscoelastic fluid to flow through the bottom Bm of the juxtaposed liquid chamber 35b to the communication path 38a, to have less influence from the magnetic powder in the magneto-viscoelastic fluid being deposited.

Still further, the active vibration control device 1J has the concavo-convex surface 39a in the juxtaposed liquid chamber 35b as a flow path of the magneto-viscoelastic fluid, as shown in FIG. 24. While securing a prescribed flow path cross-sectional area of the juxtaposed liquid chamber 35b, as a flow path of the magneto-viscoelastic fluid, at the concave portions 39a2 (see FIG. 23) of the concavo-convex surface 39a, the active vibration control device 1J as described above has the concave portions 39a2 facing the first magnetic circuit provider 38 (see FIG. 22), to increase a magnetic force in the juxtaposed liquid chamber 35b.

Hereinabove, the embodiments have been described, but the present invention is not limited thereto and various embodiments are possible. The active vibration control device 1E, 1F, or 1G according to the fifth, sixth, or seventh embodiment has been exemplified to have the one or more permanent magnets 9a arranged at one of three locations, i.e., the radially lateral face of the second magnetic circuit provider 9, the radially inner end of the orifice 15a, or the radially outer end of the orifice 15a, but the present invention is not limited thereto. Thus, the active vibration control device according to the present invention may have two or more selected, for arranging the one or more permanent magnets 9a, from the three locations of the radially lateral face of the second magnetic circuit provider 9, the radially inner end of the orifice 15a, and the radially outer end of the orifice 15a.

In addition, the active vibration control device 1J may have the magnet coil 12 replaced with the permanent magnet 24, as in the active vibration control device 1H (see FIG. 17). The active vibration control device 1J as described above is capable of switching between two stiffness levels in proportion to a level of a load inputted to the active vibration control device 1J, as with the active vibration control device 1H (see FIG. 17).

### LIST OF REFERENCE SIGNS

1A: active vibration control device, 1B: active vibration control device, 1C: active vibration control device, 1D: active vibration control device, 1E: active vibration control device, 1F: active vibration control device, 1G: active vibration control device, 1H: active vibration control device, 1J: active vibration control device, 2: outer hollow cylinder, 3: inner hollow cylinder, 5: magnetic field provider, 6: first-liquid-chamber definer, 7: second-liquid-chamber definer, 8: first magnetic circuit provider (magnetic material), 9: second magnetic circuit provider (magnetic material), 9a: permanent magnet, 11: third magnetic circuit provider (magnetic material), 12: magnet coil (magnetic field generator), 14: flexible member, 15: first liquid chamber, 15a: orifice, 17: bottom wall of flexible member, 20a: liquid, 20b: magneto-viscoelastic fluid, 21: second liquid chamber, 24: permanent magnet (magnetic field generator), 34: flexible member, 35: first liquid chamber, 35a: adjacent liquid chamber, 35b: juxtaposed liquid chamber, 38: first magnetic circuit provider (partition wall), 38a: communication path, 39: second magnetic circuit provider, 41: third magnetic circuit provider, 92: cylindrical portion of second magnetic circuit provider (radially lateral face of magnetic material), Mc: magnetic circuit provided by magnetic coil, Mm: magnetic circuit through orifice provided by permanent magnet, and MFL: magnetic field line.

What is claimed is:

1. An active vibration control device comprising:
an outer hollow cylinder;
an inner hollow cylinder arranged radially inside the outer hollow cylinder;
a magnetic field generator to generate a magnetic field;
a magnetic material to provide a magnetic circuit by the magnetic field;
a first liquid chamber filled with magneto-viscoelastic fluid; and
a second liquid chamber adjacent to the first liquid chamber and filled with liquid,
wherein the magnetic field generator, the magnetic material, the first liquid chamber, and the second liquid chamber are provided radially between the inner hollow cylinder and the outer hollow cylinder,
the first liquid chamber is separated from the second liquid chamber by a flexible member, and
a portion of the first liquid chamber works as a flow path of the magneto-viscoelastic fluid, through which the magnetic circuit is provided.

2. The active vibration control device according to claim 1, wherein
the first liquid chamber, the second liquid chamber, and the flexible member extend in a circumferential direction of the device.

3. The active vibration control device according to claim 2, wherein
a first-liquid-chamber definer to define the first liquid chamber, a second-liquid-chamber definer to define the second liquid chamber, and a magnetic field provider having the magnetic field generator are arranged so as to be aligned, in an axis direction of the device, with one another.

4. The active vibration control device according to claim 3, wherein
there are two or more units provided in the axis direction, each having the first-liquid-chamber definer, the second-liquid-chamber definer, and the magnetic field provider.

5. The active vibration control device according to claim 4, wherein
the adjacent units are arranged so as to be topologically different from each other about the axis.

6. The active vibration control device according to claim 4, wherein
the adjacent units share the single magnetic field provider.

7. The active vibration control device according to claim 1, wherein
the magnetic field generator is a magnet coil,
a permanent magnet as an additional magnetic field generator is arranged in the magnetic material, and
the magnetic circuit by the permanent magnet is provided through the flow path of the magneto-viscoelastic fluid.

8. The active vibration control device according to claim 7, wherein
the permanent magnet is arranged in at least one of: a radially lateral face of the magnetic material; an inner adjacent portion of the magnetic material, adjacent to a radially inner end of the flow path of the magneto-viscoelastic fluid; and an outer adjacent portion of the magnetic material, adjacent to a radially outer end of the flow path of the magneto-viscoelastic fluid, wherein the magnetic material is adjacent to the magnetic field generator.

9. The active vibration control device according to claim 1, wherein
the first liquid chamber includes an adjacent liquid chamber adjacent to the flexible member,
a flow path of the magneto-viscoelastic fluid is partitioned, in an axis direction of the device, from the adjacent liquid chamber via a partition wall, and
the partition wall includes a communication path communicating the adjacent liquid chamber with a flow path of the magneto-viscoelastic fluid.

10. The active vibration control device according to claim 9, wherein
the device includes a pair of the adjacent liquid chambers in a circumferential direction thereof, and
the pair of the adjacent liquid chambers communicate with each other through the flow path of the magneto-viscoelastic fluid.

11. The active vibration control device according to claim 9, wherein
the communication path is formed so as to be positioned higher than a bottom in a vertical direction of the flow path of the magneto-viscoelastic fluid, when the device is arranged to have an axis thereof horizontal.

12. The active vibration control device according to claim 9, wherein
the flow path of the magneto-viscoelastic fluid is provided with concavo-convex surface which is concavo-convex in the axis direction.

13. A method of manufacturing the active vibration control device according to claim 1, comprising:
a sealing step of sealing the magneto-viscoelastic fluid in the first liquid chamber,
wherein the sealing step is implemented by putting together the magnetic field generator, the magnetic material, and the flexible member, with all of these submerged in liquid of the magneto-viscoelastic fluid.
